(19) United States
(12) Patent Application Publication
(10) Pub. No.: US 2024/0115075 A1
(43) Pub. Date: Apr. 11, 2024

(54) AUTOMATED FOOD FRYING SYSTEMS

(71) Applicant: Henny Penny Corporation, Eaton, OH (US)

(72) Inventors: Barney Wragg, London (GB); Joe Muller, London (GB); Peter Schroder, London (GB); Richard Williams, London (GB); Chris Tait, London (GB); Thomas Lambert, London (GB)

(21) Appl. No.: 18/552,103

(22) PCT Filed: Mar. 21, 2022
(86) PCT No.: PCT/GB2022/050709

§ 371 Date: Sep. 22, 2023

(30) Foreign Application Priority Data
Mar. 22, 2021 (GB) 2103943.3
May 18, 2021 (GB) 2107058.6
May 18, 2021 (GB) 2107062.8
May 18, 2021 (GB) 2107064.4
May 18, 2021 (GB) 2107067.7
May 18, 2021 (GB) 2107069.3
May 18, 2021 (GB) 2107070.1
May 18, 2021 (GB) 2107071.9
May 18, 2021 (GB) 2107073.5
May 18, 2021 (GB) 2107074.3
May 18, 2021 (GB) 2107076.8
May 18, 2021 (GB) 2107078.4
May 18, 2021 (GB) 2107079.2
May 18, 2021 (GB) 2107080.0

(51) Int. Cl. A47J 37/12

(52) U.S. Cl. CPC A47J 37/1228; A47J 37/1219; A47J 37/1266; A47J 37/1295

(57) ABSTRACT

An automated food-fryer system is configured to automatically move a food-fryer basket (4) from a food dispense (1)r to a cooking well (3) and then to a food dump (5); the system includes a basket transport system (2) that is made up of several, separate transport modules that are configured to automatically move baskets (4), and in which the movements (i) between the food dispenser (1) to the cooking well (3) and (ii) down into and up from a cooking well (3), are independent of, or asynchronous from, each other.

### FIELD OF THE INVENTION

This invention relates to an automated food frying system.

### BACKGROUND

Automating the process of frying chips and other fried foods in commercial kitchens (e.g. fast food or quick service restaurants and dark kitchens frying potato fries, vegetable chips, hash browns, chicken nuggets, chicken wings etc.) is appealing. The conventional, manual process involves a kitchen staff member emptying a bag of frozen fries into a food fryer basket, then taking that basket and lowering it into a deep fat fryer well, and then lifting it out from the fryer well when cooked, and then pouring the cooked fries into a large stainless steel bowl, salting them, and then keeping them under radiant heat lights until they are ready to be scooped into a cartoon to give to the consumer.

Whilst apparently straight forward, the quality of the final fried food can easily be compromised in this manual process: Product quality depends on a number of factors, such as: the amount of product cooked vs the size of fry well; the time spent in the fryer; the temperature of the oil prior to and during the cook; the quality of the oil (in turn dependent on age, skimming/filtering to schedule); the temperature of the product when it enters the hot oil and whether, for frozen food, it has partially defrosted or not; the delay between frying and salting; the amount of seasoning used; the distribution of seasoning over the cooked product; the seasoning and holding environments (especially their temperature and humidity).

For example, if the food fryer basket is over-loaded with frozen fries (also referred to as ‘chips’), then that can lower the temperature of the cooking oil, leading to poor quality chips. If the chips poured into the food fryer basket have thawed slightly, then they will absorb too much oil, leading to poor quality chips. Once cooked, if they are not salted quickly enough, the chips will go soggy. If the cooked chips are held for more than 5 minutes, then they are usually meant to be discarded, but this can be ignored by kitchen staff, who will sometimes batch cook large quantities of chips and hold them for longer than 5 minutes. Also, staff do not always conform to cooking schedules, preferring to batch cook items to reduce the time they spend interacting with the fryer. They also may incorrectly judge the rate fries are being removed to meet orders, resulting in new batches being ready before the chip dump has been emptied, meaning those chips have to be dumped potentially while still viable.

In practice, kitchen staff in fast food kitchens can overload the fryer baskets with fries, either to save time, reduce the number of batches they have to cook, because of an earlier miscalculation of how many chips were required or because they are unable to correctly measure out the amounts. This causes the oil temperature to drop too low, and affects the fry and can also lead to product not being fully immersed in the oil, thus not cooking properly. In addition, kitchen staff cook in large batches: during busy periods staff will preferentially cook a single large batch consisting of multiple baskets of fries concurrently, thus limiting the spread of labour they have to exert. This leads to fries being held past their quality lifetime. Staff may not notice or are not free when fries are supposed to be removed from the fryer, leading to overcooking. After removal from the fryer, staff may not shake the baskets or give them time to drain, leading to oil remaining on the fries. After placing the fries into the dump (a heated food storage area), staff may not salt the fries, may not salt with the correct amount, or may not correctly distribute/mix the salt over the fries. Batches of fries may not be correctly labelled, leaving to confusion over the remaining lifecycle of specific batches. Fries that have passed their lifecycle may not be wasted at the correct time, and may continue to be given to customers. Freezer doors may be left open, causing product to begin to defrost causing fry quality to deteriorate. Staff may not skim the vats or start oil filtration cycles in a timely fashion.

Most commercial kitchens, especially the major well known fast-food chains, have quite specific SOPs (standard operating procedures) that are designed to address these potential problems by defining for example: the maximum batch size (e.g. the maximum weight of frozen produce that can be placed into a hot oil well for frying), the cook or drop temperature (e.g. 175° C.), the maximum hold time for food (i.e. the time the food can be held after cooking before being delivered to the consumer—typically 5 minutes), the frequency of filtering the cooking oil, the maximum customer wait times, as well as other operating rules (e.g. always closing the freezer door as soon as frozen food is removed from the freezer), never letting frozen food defrost in air etc, replacing the cooking oil when it becomes cloudy, specific fryer cleaning procedures etc.

But the reality is that in a busy kitchen, where the job of frying food is often given to the least experienced member of the kitchen team, these SOPs are not infrequently ignored, leading to compromised food quality. And operating the frying equipment is unpopular among workers because it is dirty, smelly, boring/unproductive and repetitive; frequent oil filtering is unpleasant and also requires cumbersome PPE. Even more worryingly, it is also dangerous: 80% of fast food workers have been burnt whilst working, and the majority of burn victims received their burns when operating frying equipment. Churn rate for frying staff is understandably high, and training costs are high; SOP compliance is low, and product quality is low. In summary, fast food frying has several major problems: worker injuries, poor quality control, high labour costs, and limited labour availability.

### SUMMARY OF THE INVENTION

An implementation of the invention is the Karakuri automated food frying system, called Fryr®. The Fryr system addresses the problems identified earlier and provides new functionality that enhances consumer choice, improves food quality, reduces food wastage and reduces energy consumption. The Fryr system is a complete, self-contained, automated food frying system; it is made up of a freezer section that can automatically dispense measured quantifies of frozen food into a food fryer basket (e.g. a standard food fryer basket), and a transport system for moving the filled food fryer basket into a deep frying well and then to the food dump, where it is held until used. The transport system may be made up of separate linear transport modules that can each move a fryer basket independently of other modules. The invention is defined in the appended Claims.

The Fryr system leads to many advantages: Adherence to standard operating procedures (SOPs) is enhanced, leading to better quality product, with less waste. The Fryr device is able, even whilst operating at high food production rates sufficient to meet the needs of even the busiest kitchen, to:
Correctly load frying baskets with the correct amount of uncooked chips.
Remove chips from the hot oil wells at the correct time
Drain the chips for the correct amount of time
Minimise the delay between removing chips from the fryer and salting+moving to holding environment
Season with the correct amount (customised to the quantity of chips cooked)
Ensure that seasoning is distributed over the entire batch of chips
Hold chips in a better controlled environment
Agitate chips constantly to prevent pockets of moist air forming
Guarantee that chips are wasted after their quality lifetime is exceeded to ensure they are not sent out to customers.

The following twenty three key Features are implemented in the Karakuri Fryr automated food frying system:
Feature A-D: Automated food fryer basket transport system
Feature E: Automated salter/seasoner
Feature F: Food delivery app integration
Feature G: Chip frying system with user-defined chip crispness
Feature H: Predictive setting of oil temperature in a deep fat fryer, depending on anticipated future usage
Feature I: Maintaining oil temperature in a deep fat fryer, by varying heat input depending on food batch size
Feature J: Automated start and end of fryer idle mode based on scheduling of next food order
Feature K: Automated triggering of oil filtering based on fryer throughput
Feature L: Computer vision system to identify floating debris in the fryer oil
Feature M: Automated control of different wells in a multi-well fryer based on incoming food orders
Feature N: Automated food fryer system for agitating frying baskets to separate fries from each other when immersed in oil to ensure they are evenly cooked
Feature O: Automated food fryer system to rapidly remove excess oil through from fried food following removal from the fryer
Feature P: Automated food fryer system with automatic fryer well covers
Feature Q: Automated portion packaging system
Feature R: Modular food fryer system
Feature S: Hybrid automated and manual food fryer system
Feature T: Automated food fryer system with operations scheduled using a genetic algorithm
Feature U: Automated food fryer system that tracks counts the number of portions delivered
Feature V: Automated food fryer system that tracks and times operations to enable compliance with SOPs to be verified
Feature W: Automated food fryer system with ‘buffer quantity’ cooking mode
Appendix 1 is an expanded discussion of these Features.

### BRIEF DESCRIPTION OF THE FIGURES

The following figures show features of the Fryr food-fryer system that implements the invention.

FIG. 1: a general view of the exterior of the food-fryer system.

FIG. 2: a frontal view of the exterior of the food-fryer system.

FIG. 3: an interior view of the food-fryer system.

FIG. 4: a general view of the exterior of the food-fryer system, including an autopacking unit.

FIG. 5: shows a frozen food compartment dispensing food into a frying basket.

FIG. 6: shows the basket transport system.

FIG. 7: shows a basket tipping fries into the food dump.

FIG. 8: shows a basket being manually loaded into the system.

FIG. 9: shows the frozen food dispenser being removed from the system for maintenance.

FIG. 10: shows the fryer unit being removed from the system for maintenance.

FIG. 11: shows a different variant of the food-fryer system, made up of three separate units.

FIG. 12: shows a different variant of the food-fryer system, made up of a single unit.

FIG. 13: shows the process flow through the unit shown in FIG. 12.

### INDEX

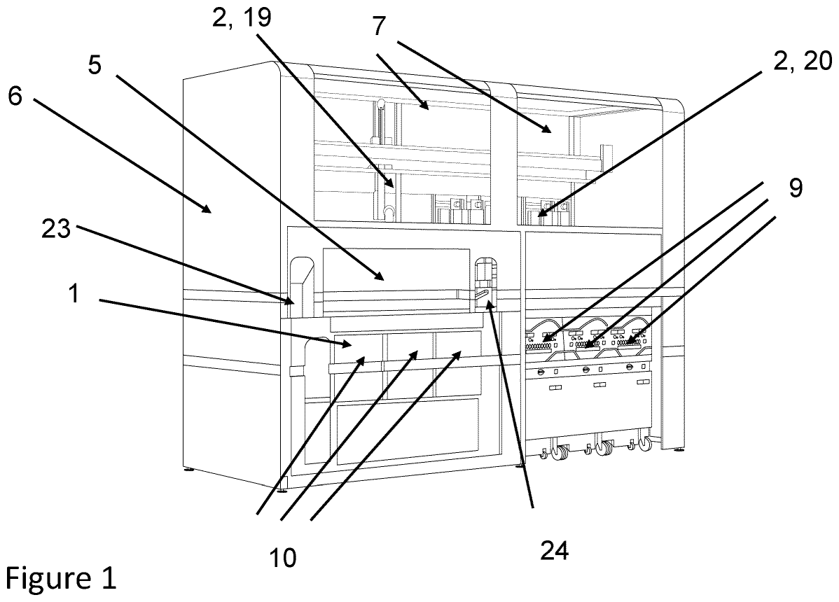

### Features in the Fryr Frying System Shown in FIGS. 1-10

Food dispenser (generally frozen food) 1
Transport system 2
Cooking well 3
Fryer basket 4
Food dump 5
Guarding 6
Glazed panels 7
Autopacking unit 8
Fryer unit 9
Frozen food compartment 10
Food exit 11
Basket gripper 13
Basket mounting hook 14
Fryer basket tray 15
Dispenser transport module 17
Link transport module 18
Main transport module 19
Well lifting transport module 20
Basket store 21
Manual basket inlet 23
Manual basket outlet 24

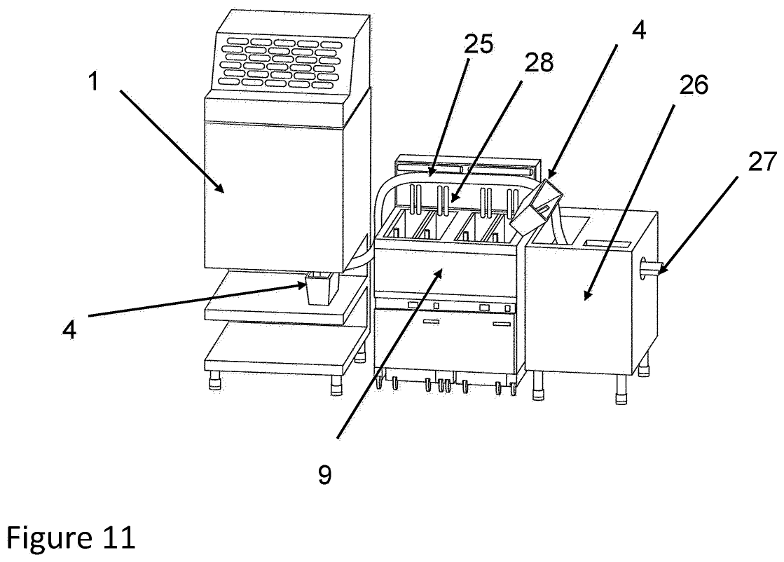

### Features in the Food Frying System Shown in FIG. 11

Single transport rail 25
Seasoner unit 26
Seasoner unit food outlet 27
Well transport 28

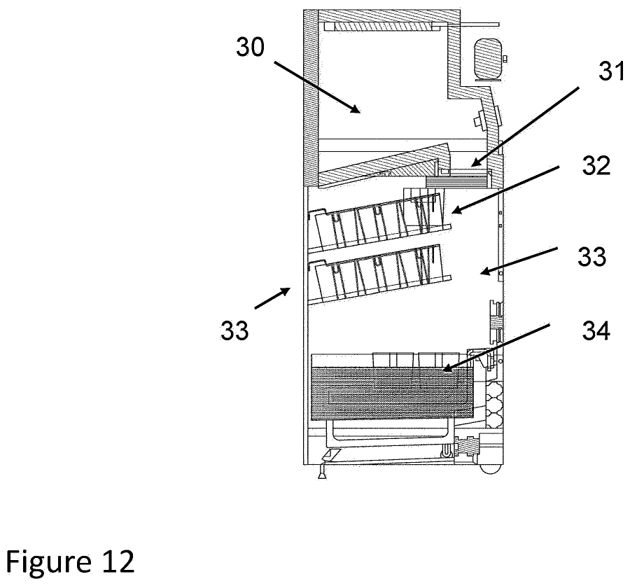

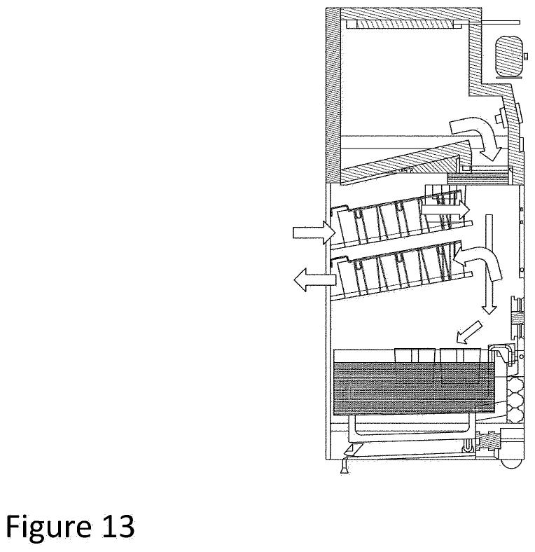

### Features in the Food Frying System Shown in FIGS. 12 and 13

Freezer dispenser 30
Portioning system 31
Empty baskets waiting to be filled 32
Vertical basket transport system 33
Fryer wells 34
Baskets with cooked food 33

### DETAILED DESCRIPTION

This Detailed Description section covers the Fryr® food frying system. The Fryr system automates the dispensing, cooking and dumping into a food hold of a range of fried products. The Fryr system enables:
Fully automated dispensing of dynamically (e.g. continuous or real-time) adjustable weights/amounts of food to be fried; e.g. frozen food from a freezer; non-frozen foods from a food dispenser. This can be done to order, or using a predictive scheduling system that predicts when food should be dispensed and the cooking process started
Fully automated frying of food (e.g. fries, hash browns, chicken nuggets, etc)
Fully automated dispensing of cooked food into a holding tray or container (often called a ‘dump’)
Fully automated discarding of food that does not meet requirements and should not be served
Fully automated packing of individual food portions (e.g. a single carton of fries)
Fully automated oil filtering
Manual cook override

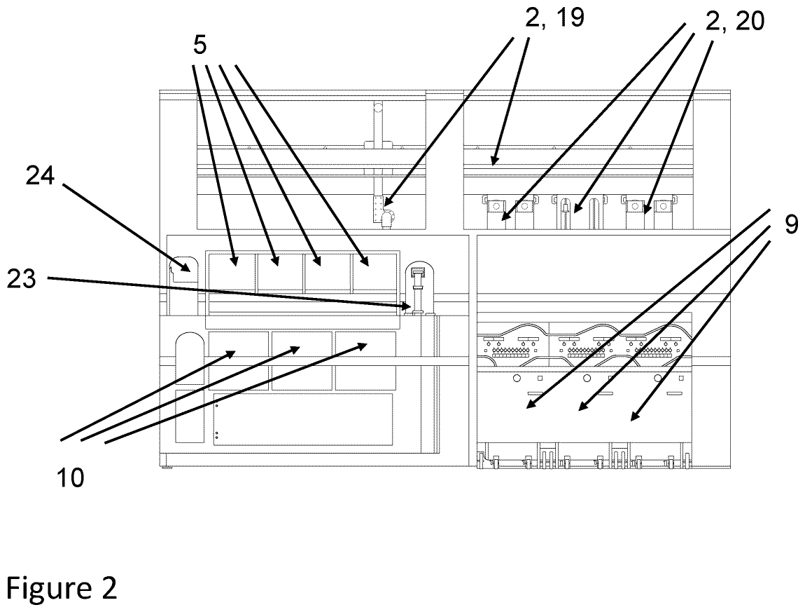

FIGS. 1 and 2 are views of the complete Fryr system. The Fryr system is made up of 6 subsystems. Automated frozen food dispenser 1, in this case is made up of three freezer drawers or compartments 10, stores the food to be fried. The drawers hold, respectively, fries, hash browns, and chicken nuggets; naturally, more freezer drawers can be added if more food types need to be automatically cooked by the system; alternatively, the Fryr system enables kitchen staff to manually insert a fryer basket into the system; that is especially useful for cooking foods that do not have their own compartment 10.

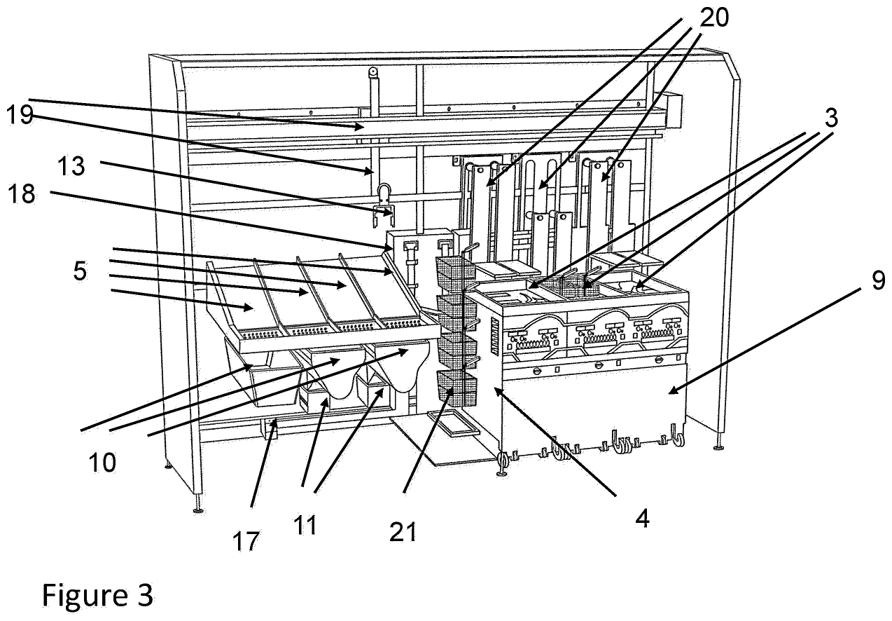

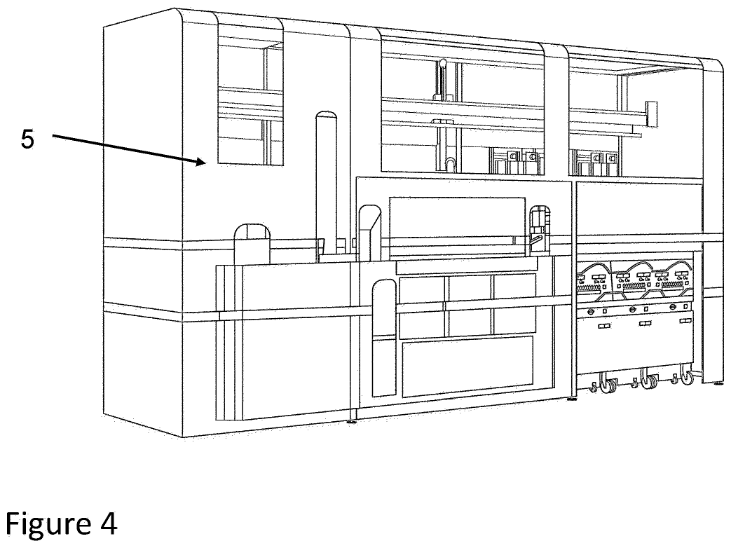

The automated freezer dispenser 1 delivers (e.g. under gravity or assisted) required amounts of frozen food directly into a fryer basket 4 (see FIG. 3) placed underneath the dispenser. A transport system 2 (shown more clearly in FIGS. 3 and 4) then moves the filled basket 4 from the freezer dispenser 1 into a hot oil cooking well 3 in one of three adjacent fryer units 9, and then lifts the basket with cooked food up from the well 3, and across to the food ‘dump’ 5, and deposits the fried food into the dump 5. Kitchen staff can reach into the dump to portion the food into e.g. a carton or paper bag to give to consumers/food delivery drivers etc.

The transport system 2 includes a mechanism for lowering and raising basket into and from a hot oil well; this mechanism is separate from the basket transport system that moves a fryer basket 4 over to the well. FIG. 1 shows two of the modules that make up this transport system 2: the main transport module 19 that moves baskets laterally across the system and also the tops of several well lifting transport modules 20, that each lower and lift up a basket from a hot oil well. The other two modules in the transport system 2 are concealed from view in FIG. 1.

Each well has its own basket lowering and raising mechanism, so that the system can simultaneously be frying multiple baskets, and can simultaneously be loading a basket with frozen fries at the same time as, for example, one basket is being lowered into a well, and another basket is being lifted up from a well and another basket is queued and waiting to be moved over to a well.

The system includes guarding 6, including glazed panels 7, around the entire unit to minimise the risks of injury and to contain airborne oil droplets and cooking odours within the unit. Whilst the system is fully automated, it does allow kitchen staff to manually slide a basket into the system, through manual basket inlet 23; this basket is then automatically transferred to a fryer unit 9 and then, once its contents has been cooked, is returned to the manual basket outlet 24.

FIG. 3 shows the system without guards. This shows more clearly the three frozen food compartments 10, and the food exits 11 at the base of two compartments 10. No basket is shown lying under a food compartment, but the horizontal dispenser transport module 17, that moves a basket to the correct compartment 10, is visible. A filled basket attaches to the link transport module 18, which lifts the basket up until it can be gripped by the basket gripper 13, part of the main transport module 19. Gripper 13 extends down to grip the basket and to move it up and over to an empty well 3; it then transfers it to the well lifting transport module 20. Well lifting transport module 20 lowers the basket into the well 3; once the required cooking time has elapsed, it lifts the basket back up, shakes it to dislodge excess oil, and then gripper 13 collects it and moves it to an appropriate chute in food dump 5, then tipping the basket over the chute.

The Fryr system also has an optional add-on Autopacking unit 8, shown in FIG. 4, which automates the packing of individual portions of freshly cooked fries into containers, e.g. cartons used by food delivery services, allowing for complete end-to-end automation of the process.

The Fryr system is designed to be a near drop-in replacement for both existing equipment and labour, supporting all current products and processes. Because the Fryr system is a data enabled device, it can count the actual numbers of portions of food that are cooked (conventional restaurant management systems naturally count the number of portions sold, but configuring the actual food frying system to count the actual numbers of portions cooked and supplied (e.g. not discarded because they were held in the dump for too long) has many advantages: first, since the kitchen will know how many bags of ingredients (e.g. bags of frozen fries) it used over a day, having data on the actual numbers of portions cooked and supplied gives a clear picture on the amount of food wastage (e.g. spillages of frozen food; letting frozen food de-frost and hence become unsuitable for frying; food discarded because it was held in the dump for too long).

The Fryr system can accept input (e.g. an instruction to dispense food from a compartment 10) from both staff in-store and external systems. This allows forecast production rates to be set manually or automatically, and for staff to alter products according to in-store conditions (e.g. when those conditions require a change to the predicted scheduling of food dispensing from the compartments 10). Over time, this can enable experienced staff knowledge (e.g. when to schedule food dispensing from compartments 10) to be learnt by the system.

The data-centric approach used in the Fryr system also enables a Price per Portion model for the supply and maintenance of its Fryr units; this model allows restaurants to benefit from the labour reduction Fryr brings, and in a way that scales with their traditional labour costs, but without the normal capex associated with buying kitchen equipment.

We will look now at each of these subsystems in more detail. First, the food (e.g. frozen food) dispenser 1.

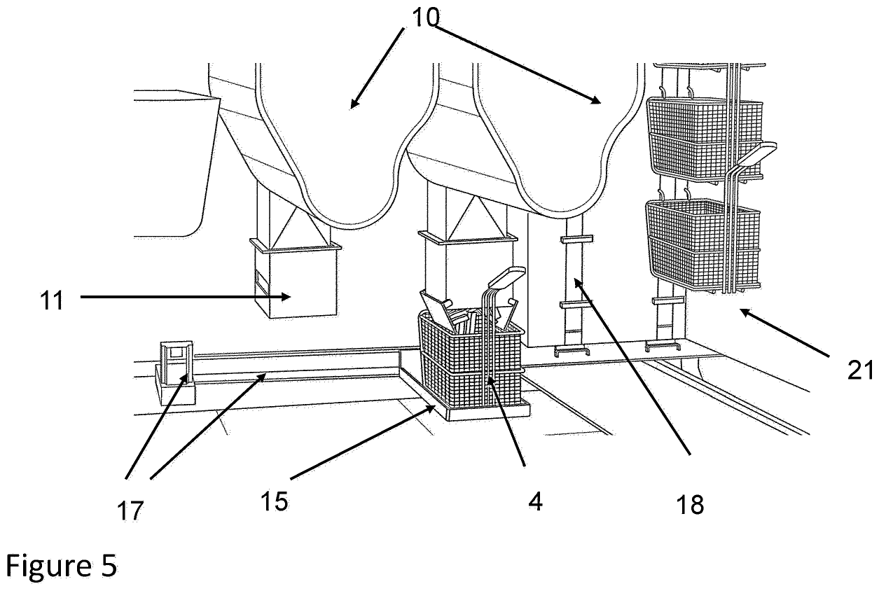

The food dispenser 1 holds frozen product, both for automated and manual dispensing; it enables the dispensing of food in precise, but variable (including dynamically or real-time variable) amounts. It has three main drawer compartments 10 (see FIG. 3); product is dispensed (see FIG. 5) from the base of each compartment 10 through a food exit 11 (e.g. a chute with a simple motorised door to open and close the end of the chute). Food drops into a fryer basket 4 held by the transport system 2. The mass of product that is automatically dispensed from a compartment 10 into a specific fryer basket 4 is weighed (e.g. using a strain gauge or other weight sensor associated with that fryer basket, e.g. integrated into the tray 15); the mass can be varied automatically, allowing for fully dynamic batch sizing.

FIG. 5 shows the horizontal transport rail 17 under the food compartments 10; fryer basket 4 rests on a tray 15 that is attached to the horizontal transport rail 17; this enables the tray 15 and hence basket 4 to be moved horizontally, to position the basket 4 under the correct food compartment 10, and to then move it to the next part of the transport system, which is a vertical basket lift 18. Vertical basket lift 18 lifts the basket 4 off the tray 15 and up away from the frozen food compartments 10.

A compartment 10 may have no automatic dispenser and instead allow for storage of low-volume product in bags to be used for manual transfer into baskets. So kitchen staff can manually fill a fryer basket and then move that basket into the manual basket inlet 23; the automated operation then takes over.

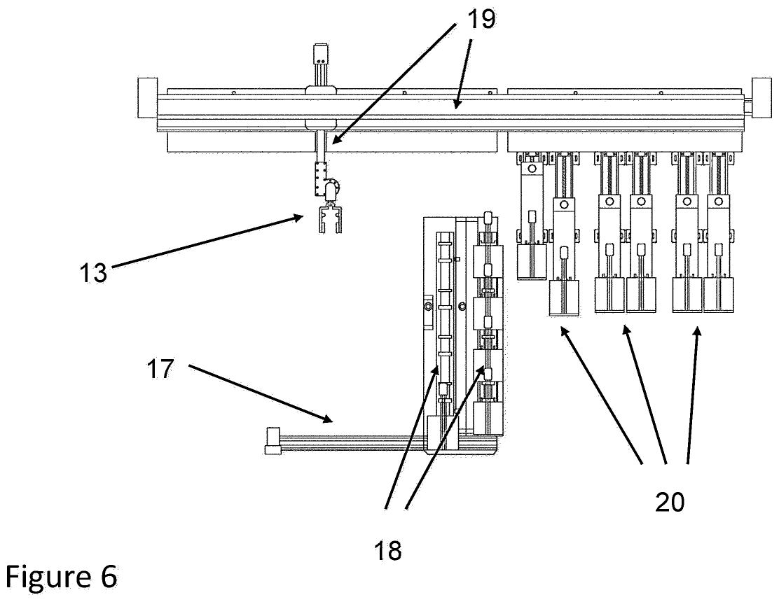

We will look now at the fryer basket transport system 2 in more detail. FIG. 6 shows the fryer basket transport system 2, removed from the rest of the Fryr system for clarity. The transport system is made up of four separate, independent linear movement devices or modules. Under the food dispenser, we have a dispenser transport module, 17 that runs along and includes a horizontal rail. Dispenser transport module 17 moves baskets under the correct freezer compartment. The filled basket is then picked up by the vertical link transport 18, at the side of the cooking well and moved vertically up to the main transport module 19, which grips the basket using gripper 13, lifts it and then moves the it horizontally until it is over a suitable (e.g. correct temperature) cooking well. Note that the vertical link transport 18 also serves as a queue or buffer that can hold filled baskets of uncooked food, waiting for the main transport module 19 to return to pick up the highest filled basket at the top of the queue. When the basket is in position, it is transferred by the gripper 13 to a well lifting transport 20, which moves the basket down into the well; there are six independent fry well lifting transports 20 shown in FIG. 6, divided into three pairs, i.e. two for each well. Hence, each well can have two baskets in it at any one time.

The basket remains in position for the required frying time, and then fry well lifting transport 20 lifts the basket out of the hot oil. The basket is gripped by gripper 13 and the main linear transport 19 then moves the filled basket until it is over an appropriate food dump; it then deposits the fried food into the dump. It then returns the empty basket to the vertical basket store 21. The empty basket is subsequently collected by the freezer dispenser transport 17 and positioned under a food compartment, and the cycle begins again.

As noted above, there are four separate, independent linear movement devices or modules: (1) a dispenser transport module 17, running underneath the freezer compartments 10; (2) link transport module 18, at the side of the food dispenser; (3) the main linear transport module 19; and (4) well lifting transport module 20 (two for each well).

A number of benefits flow from there being 4 separate movement systems or modules, each performing a simple linear motion: Efficient use of space; increased throughput; cheap, reliable, robust; reduce time criticality on interactions.

Having separate transport modules is advantageous for several reasons.
Firstly, there are several aspects of the frying process which are time critical, such as lifting the product out of the oil when it has completed cooking. Separating the transport systems ensures that they are always available for these time-critical tasks—e.g. the well lifting transport module is dedicated to only lifting the basket in and up from a well and can hence be guaranteed to operate at the correct time.
Secondly, separate modules allow for independent execution and queuing of tasks, allowing Fryr to achieve the required high throughput.
Finally, by separating each movement into linear actions, Fryr utilises proven and cost-effective technologies that allow for robust and highly-reliable operation. In the event that part of the system does require repair, functions of Fryr can continue to be utilised. For instance if the vertical transport link is unavailable, staff can continue to benefit from the well lifting system controlling cook times, and lessening the criticality of staff interaction timing.

So, as noted earlier, each well has its own basket lowering and raising mechanism 20, so that the system can simultaneously be frying multiple baskets, and can simultaneously be loading a basket with frozen fries at the same time as, for example, another basket is being lowered into a well using well lift mechanism 20, and another basket is being lifted up from another well, using a different well lift mechanism 20 and another basket is being moved up and away from the frozen food dispenser with vertical link module 18, with several baskets with frozen food queued lower down in the vertical link module 18, and yet another basket is being moved along the main linear transport 19 to position that basket over an empty well A computer is of course used to schedule and synchronise all actions, ensuring that scheduled production of fried food is automatically adhered to, and that all SOPs are also automatically adhered to.

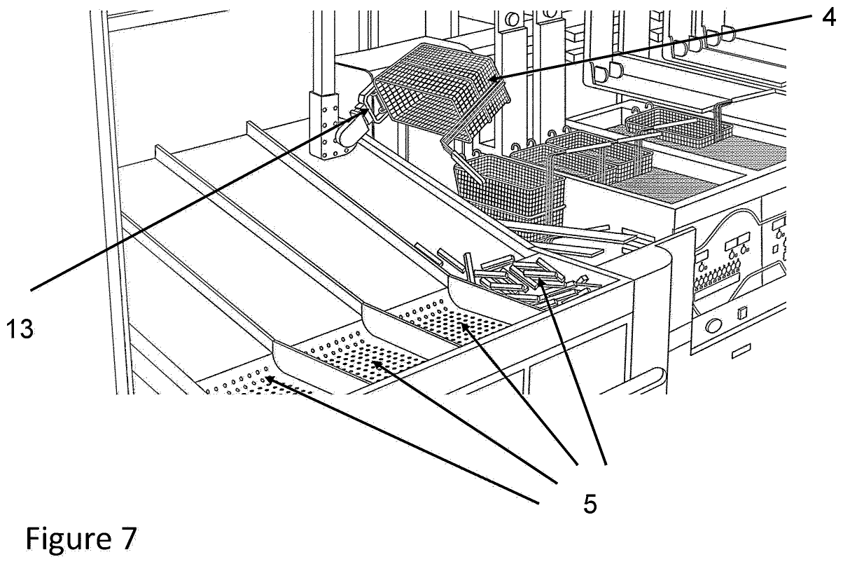

We look now at the Fry or Food Dump 5, shown in FIG. 7. The Fry Dump 5 sits on top of the freezer dispenser 1 subsystem and holds cooked product to temperature and allows staff to package and store product before it is expedited to customers. Basket gripper 13, forming part of the main transport module 19, is shown rotating to tip up a basket 4, leading to the fries that were in basket 4 now moving to one of the four lanes in the food dump 5.

The fry dump 5 supports a large proportion of staff interactions.
four lanes allow for separation of batches and product—especially useful where segregating foods is desirable (e.g. one lane could be reserved for just fries, another lane for just chicken; if there are fries that are close to their time limit in one lane (e.g. 5 minutes for some quick service restaurants), then fresh fries could automatically be deposited in another lane, to avoid getting mixed up with fries that are less fresh and might have to be discarded).
Product is hot held before and after packing.
Gravity feed chute ensures staff remain separated from automation.
Hold-time tracking
   Batches can be tracked from the moment a cook finishes.
   Batch age and expiry can be clearly communicated to staff via the HMI.
Output tracking
   This allows for metrics to be surfaced on the entire frying process, not possible with current equipment.
   Furthermore, this offers to opportunity to dynamically vary production rate based on real-time output rate.

The fry dump 5 features four separated lanes for product holding and packing. This allows batch separation to be consistently maintained. As the Fryr system controls the cooking process, accurate information on the age of each batch will also be communicated to staff, to ensure that wasted product is disposed of appropriately. Additionally each lane has separate space for holding packaged product, ready for expedition. The Fryr system will ensure that product is heated while it is being held. The fry dump may use heat lamps to maintain temperature, and also heat from the freezer.

Design Optimisation: The fry dump 5 has been designed to allow maximum flexibility in future iterations, without affecting function. Surface features such as lane separation are made from formed sheet stainless steel. This allows such features as the number, size and shape of lanes to be easily adjusted following feedback.

Output Tracking: Optionally, a vision system can be added to the fry dump 5 to independently track the amount of cooked product available. This closes the data loop and can provide real-time product availability data.

Seasoning: In the UK, product is not seasoned after cooking, however this is not the case in a large number of locales. The Fryr system can include the dispensing technology for automated seasoning modules, and the system is designed to be able to integrate these.

The Fryr system is fully automated and requires no regular human intervention, other than filling the dispensers with frozen food and collecting cooked food from the food dump 5. In addition, it also supports manual Input and Output. The Manual Input 23 and Output 24 points allow the Fryr system to handle product outside of that which is dispensed automatically, whilst retaining the other automation benefits the Fryr system brings such as enforced cook time, and superior environmental hot holding.

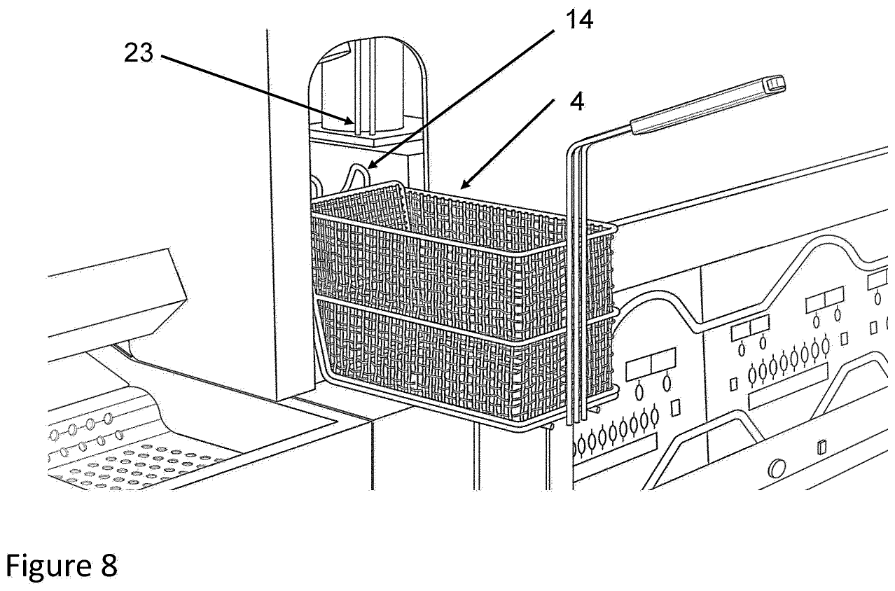

As well as bringing support for other products, it also enables the use of baskets outside of those normally used, such as those used for hash browns. As noted earlier, the Fryr device includes a manual basket inlet 23 (see FIG. 1) and shown also in FIG. 8. An operator is able to load a fryer basket 4 with food and to push the basket onto rails that lead into the inlet 23, to engage with vertical link transport 18, which picks up the basket, and lifts it to main linear transport 19; the rest of the cooking and dumping process is as before. Pull-out trays are integrated to hold a basket and collect crumbs whilst it is manually filled. This partial-separation of the manual process from the fully automated frying system has two other important functions: First, it serves to decouple manual interactions from those scheduled to occur by the Fryr device. This alleviates any sensitivity of the system to the input/collection frequency by staff, i.e. staff are not under pressure to immediately remove baskets from the system once cooked but instead have the freedom to finish current tasks, without disrupting food production. Secondly, it serves to keep staff safely separated from the automated portions of the system, allowing operation of and around the Fryr device without requiring excessive PPE or precaution.

Autopacker Option

The autopacker option (see FIG. 4) is an add-on unit 8 that automates the packing of fries into containers. Autopacker 8 receives product freshly cooked from the Fryr device, optionally seasons it, and automatically portions it into containers, all without requiring any staff interaction. The portioning compartment and storage area for packed product is heated. This means that a hot chain from fry well through to packing and holding can be guaranteed, for the best possible quality. The autopacker 8 shown here is designed to handle cardboard cartons, but other options popular with meal delivery services, e.g. paper bags, can also be handled.

Frame and Guarding

The Fryr device is designed to be a drop-in replacement for existing professional kitchen equipment. As well as fitting into existing footprints, this means ensuring staff can continue to work safely and in close-proximity. Guarding 6 (see FIG. 1) ensures staff are kept safe, but is designed to allow for easy access for cleaning.

To ease installation the unit is freestanding, and designed to decompose into transportable elements. Fryr's framing has been designed to allow staff to work in close proximity without danger whilst also retaining access to all key parts of the system for cleaning, maintenance, etc. The framing is freestanding, and does not require any specific modifications to kitchens to install. Hinged compartments allow access to all of Fryr's modules, including the fryer. These also allow the fryer to be removed from the system for maintenance. Note that the main controls to the fryer always remain accessible.

Due to the enclosed nature of the frame, there is additional opportunity for extraction to be built into Fryr.

Cleaning and Hygiene

All parts of the Fryr device that are in regular direct contact with food, such as the dispenser hoppers and the fry dump chutes, are removable for ease of cleaning in the standard customer store sinks. All direct and indirect food contact parts and those located in splash zones are hygienic and durable, made from stainless steel and food-grade plastics and are easy to access and wipe clean with a cloth and degreaser. Access underneath the Fryr device is facilitated by the fact the freezer dispenser units and the fryers can be wheeled out of the guarding to allow for cleaning underneath and behind them.

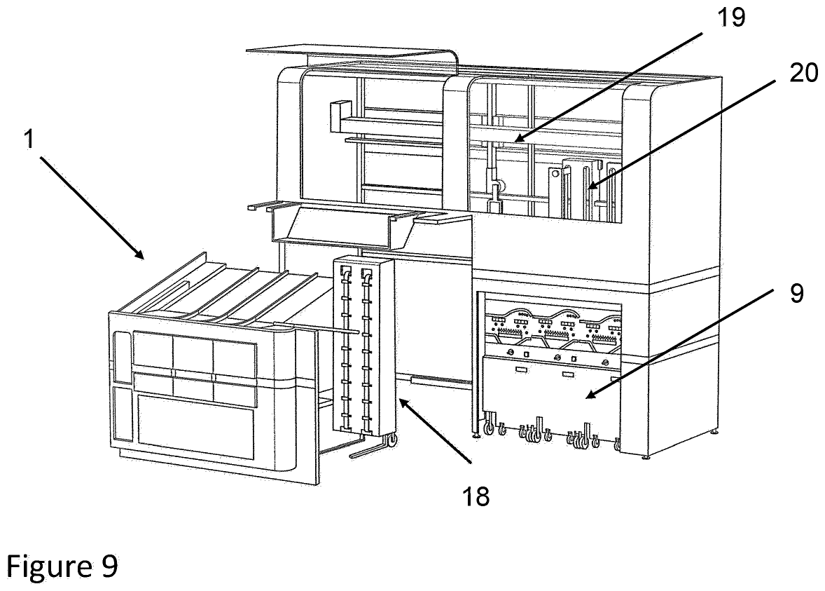

FIG. 9 shows the wheeled dispenser unit 1, together with dispenser transport 17 and vertical basket lift 18, all together forming a single unit, being moved out of the main body of the Fryr system. The main transport module 19 and the fry well lifting transport 20 remain in the main body of the Fryr system. The three fryer units 9 also remain in the main body of the Fryr system

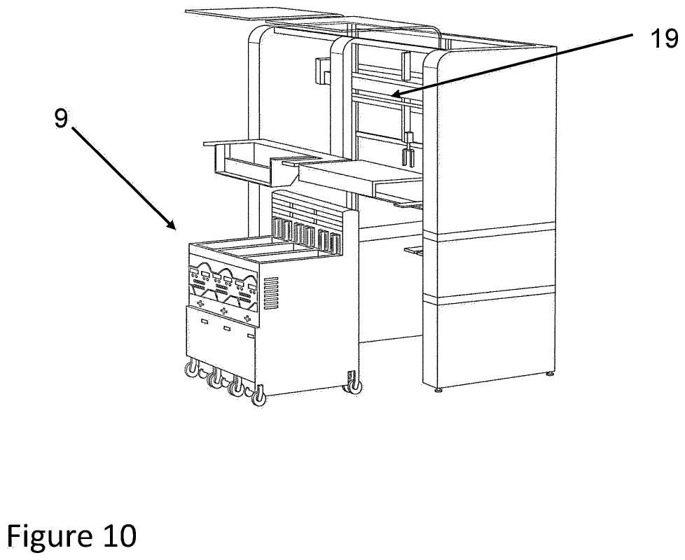

FIG. 10 shows the wheeled fryer unit 9 being removed for cleaning or maintenance. The main transport module 19 and the fry well lifting transport 20 again remain in the main body of the Fryr system.

The Basket

The fryer basket 4 is essentially similar or identical to a standard, conventional commercial food fryer basket, with sides and floor made of nickel plated wire mesh. It includes a mounting hook 14 (see FIG. 8) designed to enable the basket 4 to be attached to a corresponding mounting device (e.g. a simple lip the hook can engage with) on each the different transport modules that move the basket around; in addition, the mounting hook 14 is designed to be readily attached to the robotic end-effector gripper 13 that extends down from the main transport module. The mounting device is designed to passively hold any standard fry basket in a precisely located position.

Control Systems

The Fryr system uses Karakuri's developed control systems to orchestrate the automation system. This includes control of internal systems, integration with the installed fryer, and offering API endpoints for integration with external systems.

The Fryr system issues commands to the installed fryer. This allows the Fryr system to issue cook commands, receive cook time estimates, receive alerts etc, while allowing the fryer controller to dynamically adjust cook time, control filtering valves etc. This means that the Fryr system can benefit from the extensive empirical testing performed by fryer manufacturers to generate cook cycle data.

The Fryr system also can be operated completely manually in the event of a system failure—e.g. kitchen staff can manually add frozen food to frier baskets, and manually lower them into the heated wells, and manually lift them back up and out and tip their contents on to the dump.

Production Control

The Fryr system produces product at a dynamic rate, according to different inputs. These inputs can be real-time adjustments from staff in-store via the system's user interface, or API endpoints from external systems.

Where available (depending on locale), the Fryr system's base production rate will be set by the customer's forecasting data. Staff in store will be able to override this base rate via the system's UI, either as a pre-emptive alteration to the forecast, or with immediate effect during service, e.g. if an unexpected large party enters the store. Permission levels for who is able to alter this rate, and to what extent, will be configurable per machine. The Fryr system will collect data on these manual interventions and can use this data to improve forecasts based on the real reactions in-store. This ensures that the knowledge currently held in staff experience is efficiently retained in-store, without having to rely on manual data input by staff. As the input to the Fryr system's production rate is software-driven, new sources can be added. For instance, if a franchisee installs a camera system to support live demand prediction it will be possible to integrate this into the Fryr system without requiring any change to the hardware installation.

Workflows

This section will provide an overview of the workflows required to operate the Fryr system. There are general daily operation and cleaning workflows and also product-specific workflows.

Daily Operations

During daily operation there are two tasks that must be undertaken at regular intervals: refilling the freezer drawers and filtering the oil. Each of these tasks is summarised below.

Refilling freezer drawers: the Fryr system user interface will inform the user that a refill is required
Fries and Chicken nuggets
   Open the automatic freezer drawer
   Empty frozen product into hopper
   Close drawer
Hash Browns and Bites
   Open the manual freezer drawer
   Place bag(s) into drawer
   Close drawer

Oil filtering: The system will automatically filter the oil in each well every 16 cook cycles per well if used with a fryer that supports automatic filtering. Regular and effective oil filtering reduces oil waste. This frequency can be adjusted if desired and also varied depending on the product. Observations during the site visits indicated that oil quality degrades faster when cooking chicken nuggets than fries, due to the crumbs that come off the chicken nuggets.
If oil skimming or deep cleaning is required to remove debris from the oil, the user can select this option from the user interface
   This pauses the system and releases the fryer door lock
   The user opens the door and skims the oil or scrub the well
   The user closes the door

Typical Customer Workflow and Fryr Workflow

The below tables show a comparison between the current workflows for each product and the workflows that the Fryr system will facilitate.

Fries and Chicken nuggets

| | Typical Customer workflow | Fryr workflow |
|---|---|---|
| Both | Get product from walk-in | Get product from walk-in |
| | freezer and refill small freezer | freezer and refill freezer drawers |
| Both | Get bag from small freezer | Automated |
| Both | Empty product into basket | Automated |
| Both | Put basket into oil | Automated |
| Both | Start program | Automated |
| Both | Shake basket after Xs | Automated |
| Both | Remove basket from fryer | Automated |
| | when timer beeps | |
| Fries | Empty basket into fries dump | Automated |
| Fries | Package fries | Package fries/Automated if |
| | | using Autopacker |
| Chicken | Tip basket into hot holding | Product automatically dumped |
| nuggets | tray | to tray in Fry Dump |
| Chicken | Take hot holding tray to hot | Take hot holding tray to hot |
| nuggets | holding cabinet | holding cabinet |

Hash Browns/Bites/Generic bagged products

| Current | Fryr |
|---|---|
| Get product from walk-in | Get product from walk-in |
| freezer and refill small freezer | freezer and refill freezer drawers |
| Get bag from small freezer | Get bag from freezer drawer |
| Empty product into basket | Empty product into basket |
| Take basket to fryer | Put basket into the system IN queue |
| Put basket into oil | Automated |
| Start program | Automated |
| Shake basket after 30 s | Automated |
| Remove basket from oil when | Automated |
| timer beeps | |
| Remove basket from fryer | Remove basket once it is in the OUT |
| | queue |
| Empty product onto hot holding | Empty product onto hot holding tray |
| tray | |
| Take hot holding tray to hot | Take hot holding tray to hot holding |
| holding cabinet | cabinet |
| Package product | Package product |

Installation and Initial Setup

The Fryr system is designed as a set of freestanding separate subsystems that can be individually moved into position before being connected together. This enables the system to fit through doorways into kitchens to limit disruption. Once connected together with a fryer, the system can be connected to power (3-phase) and internet (ethernet) and turned on. Installation engineers will make sure the system is aligned on the floor, secured, and also positioned correctly under the extraction system. The system will be commissioned and fully tested with product.

Quality Opportunities and Data Collection

The Fryr system offers a number of opportunities from labour reduction and quality improvement, to enhanced data collection and forecasting.

Quality Improvements

Whether fully or partially-automated, the Fryr system cooks all product completely to the programmed SOP. This includes features such as:
Controlled batch sizing
Enforced cook time with automatic lifting
Controlled time limit moving product from freezer to fry well
Minimum well temperature guaranteed prior to cooking
Enforced actions such as basket shaking and oil draining

The design of the Fry Dump also allows staff to better manage fry batches and ensures that batch separation and age is clearly communicated. By adhering to SOPs, the Fryr system ensures that fried product is consistently produced to the highest quality possible.

The Fryr system also increases quality via oil care. Where a suitable fryer is installed, the Fryr system will automatically perform filter cycles when required, ensuring that oil remains in good condition. Where a fryer requiring manual filtering intervention is installed, the Fryr system still offers opportunity for increased quality. The Fryr system tracks the oil status of each fry well available (based on factors including time since last filter and product volume cooked) and if it detects that staff are not performing a filter in a timely manner when requested, such as during a busy period, the Fryr system will preferentially use wells with better condition oil where possible, thus maintaining the highest quality output.

Data Collection

As discussed above, the Fryr system will use staff interactions to improve forecasting over time. Alongside this, there are a number of data collection opportunities that will offer insights into parts of the frying process not possible with traditional equipment. By controlling the frying process, the Fryr system allows for much more accurate and granular data to be collected on product availability, and wastage. As the Fryr system controls both the dispense and cooking process for its fully-automated products, accurate data will be collected on both the timing of the cooks and the batch size of each cook. This will allow for accurate recording of the amount of product produced. Combined with the Fryr system's ability to track the output rate of product from the dump, this will enable enhanced data on product availability and wastage.

Cooking Modes

The Fryr system supports several different cooking modes: Cook on demand; cook to order; cook to learned schedule; and cook to a preset product availability quantity.

Cook on Demand: An Operator:
1. presses a button to initiate a cook cycle; the operator uses their skill and judgement to decide when to do this.
2. sets a production rate (e.g. the number of batches or baskets of food to be fried over a set time),
3. can override the current production rate (e.g. with a ‘cook as fast as you can go’ button, that sets the production rate at its maximum)

Cook to order: Here, it is an order for a food item that initiates a cook cycle for that food item. Orders can be aggregated into batches at the cost of delay. This mode minimises wastage at the expense of order fulfilment latency.

Cook to a learned schedule: A production schedule is determined a-priori based on learned information about customer behaviour, including variable environmental factors such as the weather, finish time of local football match, automatically determined measures of restaurant busyness anticipating order requests etc. See also the following ‘Optimised cook schedules’ section.

Cook to product availability quantity: the Fryr system supports a hot hold area that stores cooked product. The amount of product in this area is the ‘buffer’ between the cooked batches and the individual portions being served and is the ‘available product’.

When the restaurant is not busy, to minimise waste, the amount of available cooked product in the buffer should be minimised due to its short shelf life (in the case of chips this can be as low as 5 minutes). In this scenario, waste is minimised with zero cooked product in the buffer, equivalent to the ‘cook to order’ mode.

At busy times the amount of available product needs to be high to minimise waiting times and maximise the restaurants throughput. Waste is not an issue in this condition, everything will be sold.

At transition times, the optimal size of the product buffer is determined from the current order frequency measured over a time period similar to the cooking time. In practice this may be low pass filtered to provide a smoother signal and potentially coupled with a look ahead calculation based on the rate of change of order frequency so that the buffer demand responds quickly to a rapid increase in the order frequency.

In this control mode, the production rate is closed loop controlled to maintain the current demanded buffer size as the buffer is depleted by order fulfilment. So for example, the buffer size, or available product amount, could be five portions of fries—e.g. the system tracks how many portions of fries are ordered, and cooks at a production rate sufficient to ensure that there will be approximately five portions of fries in the food dump over a set future time window (typically the cooking duration for that food item—e.g. 3 minutes for fries). This approach has the advantage that waste is minimised at quiet times and production automatically increases and decreases with demand whilst always maintaining enough cooked product for serving customers without excessive delay.

This control method requires no AI or machine learning systems, complex prediction systems or manual intervention and only requires integration with the Point of Sale system to provide the order information. It ensures quality fried product is always available for customers, minimising wait times whilst also minimising waste.

Additionally, manual overrides can be provided to rapidly fill the buffer or empty it or simply set the desired level. This is much like manual control of the production rate but has the advantage of stability with respect to the buffer size.

Optimised Cook Schedules

The optimised cook schedules implemented by the Fryr system are generated by a state of the art Genetic Algorithm (GA) which is a class of computational model that applies evolutionary theories to solve complex optimisation problems. The inputs to the GA are the Fryer Transactions, SOPs and the physical limitations of the frying process (well configuration, oil management etc).

The GA takes these inputs, generates candidate cook schedules and scores these schedules based on how many fried product orders are met and how much waste for each product is generated. The best candidates are then selected and mutations (e.g. adjusting batch size or cook start time) are applied to each to generate a new set of candidate schedules taking features from the best. This process is repeated until an optimised cook schedule is found. In this way we were able to generate cook schedules which fulfilled orders strictly within SOP, took into account all the physical limitations of the frying process (well configuration, oil management etc) whilst also minimising waste. A Genetic Algorithm is selected due to the inherent nonlinearity of the problem, that is, optimising cook schedules for multiple fried products with different physical constraints (cook times, hold times, batch sizes).

The requirements that the Fryr system meets can be summarised as follows:

Global Requirements

| Requirement | Description |
|---|---|
| Scalability | Fryr must be able to support configurations |
| | of between 2-5 fry wells (or more), |
| | depending on store capacity requirement. |
| Emergency Manual | In the event of a system breakdown, Fryr |
| Operation | must not prevent a store from manually |
| | producing fried product. |
| Layout Flexibility | Fryr must be manufacturable in both left and |
| | right-handed configurations, in order to |
| | accommodate existing store layouts. |
| Throughput | Fryr must have capacity to handle 120-150 |
| | frying transactions in a 15 minute period. |
| Throughput | Fryr must have capacity to handle up to 500 |
| | frying transactions in a 60 minute period. |
| Footprint | Fryr must fit into a footprint of 2-4 m(L) × |
| | 1 m(D) × 2 m(H) (including fryer), or other |
| | dimensions |
| Manual product support | Fryr must offer the ability to handle existing |
| | and future products that are currently too |
| | low-volume to justify automation. |

Labour Requirements

| Requirement | Description |
|---|---|
| Labour Reduction | Operation of Fryr will not require a dedicated |
| | member of staff >90% of hours compared to |
| | current manual cooking practice. |

Product Compatibility Requirements

| Requirement | Description |
|---|---|
| Fries | Fryr shall support the automatic dispensing, |
| | frying, dumping, and hot holding of the Fries. |
| | An optional Autopacking unit will support |
| | the automatic packaging of the Fries. |
| Chicken nuggets | Fryr shall support the automatic dispensing, |
| | frying, and dumping of the chicken nuggets |
| Hash Browns | Fryr shall include freezer space for bagged |
| | hash browns and a manual input for hash |
| | brown baskets which will then be |
| | automatically fried |
| Bites | Fryr shall include freezer space for bagged |
| | bites and a manual input for baskets which |
| | will then be automatically fried |

Process Requirements

| Requirement | Description |
|---|---|
| Basket Shake | For fries, chicken nuggets, and bites, the |
| | system shall shake the basket X seconds after |
| | cook start to aid product separation and even |
| | product distribution |
| Basket Oil Drain | The Fryr system will allow excess oil to drain |
| | from the basket immediately after cooking |
| System Cleaning | The Fryr system will be designed so that parts |
| | requiring removal for cleaning can be |
| | removed easily without any tools |
| Oil Filtering | The Fryr system will schedule oil filtering |
| | operations automatically |
| Oil Management | The Fryr system will allow for users to test |
| | oil quality in accordance with the Oil |
| | Management SOP |
| Fryer Cleaning | The Fryr system shall allow access for |
| | normal fryer cleaning operations to take |
| | place, including well scrubbing, skimming, |
| | and oil refilling |

Integration

| Requirement | Description |
|---|---|
| Kitchen Management | The Fryr system shall offer API endpoints to |
| Software Integration | allow interfacing with KMS as installed at |
| | customer sites |
| Stock Control Software | The Fryr system shall offer API endpoints to |
| Integration | allow interfacing with stock control software |
| | as installed at customer Sites. |
| Fryer Integration | Fryr shall integrate with commercially |
| | available fryers. |
| Basket Compatibility | Fryr shall support automatic and manual |
| | processing using e.g. a standard 14″ customer |
| | frying basket, and the manual processing of |
| | the Hash Brown basket. |
| Extraction | Fryr shall be compatible with existing |
| | overhead ceiling-mounted extraction |
| | solutions currently installed in stores. |

Control Interface, Feedback, Data

| Requirement | Description |
|---|---|
| User Information | The Fryr system shall provide a user |
| | interface, along with optional API |
| | integration endpoints to inform users |
| | on items including refill alerts and |
| | system status. |
| Automated Production | The Fryr system shall offer API integration |
| Control | endpoints to facilitate the automated control |
| | from an outside system of forecast and real- |
| | time production rates, or to request specific |
| | batch cooks. |
| Manual Production | The Fryr system shall allow an operator to set |
| Control | forecast production rates, adjust real-time |
| | production rates, or request a specific batch |
| | cook via a user interface |

Other Food Frying System Variants

FIG. 11 is another variant of the Fryr food frying system, where the frozen food dispenser and frying wells are not part of a larger integrated unit, but are smaller, separate unit. In FIG. 11, the freezer dispenser 1 dispenses frozen food, of a desired and variable amount into a fryer basket 4 mounted on a load cell (or other weighing system) that weighs the contents and sends that data to a computer; the weighing system means that each fryer basket can have a customised or specific weight of food delivered into it, enabling mush more sophisticated scheduling and management of food production.

Fryer basket 4 runs on a single transport rail 25 that moves the filled fryer basket 4 away from the dispenser 1, and over the frying wells. Vertical transports 28 lower the fryer basket 4 into the oil, and raise it from the oil after a set time; these vertical transports 28 operate independently and asynchronously compared to the single rail 25 transport system. Single rail 25 transport system moves the basket 4 after cooking to a seasoner unit 26; it then tips the fried food into the seasoner unit 26, which then agitates, dehumidifies and seasons the food. It releases the seasoned food through food outlet 27.

The seasoner unit 26 is configured for the automated dispensing of seasoning of a user-specified type, and user specified amount. It can automatically agitate the food product without damaging it and can demonstrably extend the quality lifetime of fried product. It can automatically dispense product into containers and can automatically bin or dispose of product that is past its lifetime.

The advantage of this small, modular approach, compared to the larger design, is that it can fit more readily into existing workflows/layouts; existing kitchens are constrained in space and this solution can more readily work within the floorplan of existing elements and not require people to working around the hardware. In particular, the rail system can be shaped to conform to the path available between the modules.

FIGS. 12 and 13 show another format, this time a single integrated unit with the same footprint as a typical fryer (e.g. 450 mm×820 mm base in a single casing that is 1930 mm tall). This device includes a frozen food dispenser 30 that sits directly over a row of empty baskets waiting to be filled 32. The basket at the top of the row is moved under a food portioning system 31 that delivers a weighed amount of frozen food into the basket. A vertical basket transport system 33 (omitted) then moves this filled basket down and into a heated oil well 34, lifting it up and out after the required time and adding it to a row of baskets 33 with cooked food in them; kitchen staff then manually remove the baskets with coked food 33 and dispense the cooked food into a convention dump, returning the empty basket to row 32. FIG. 13 shows the movement or flow through this integrated unit.

### APPENDIX 1

Key Features

In the following sections, we will focus on the specific Features A-W listed above. Each Feature can be combined with any other Feature; each optional feature defined below can be combined with any Feature and any other optional feature.

Other aspects are a meal prepared using the device or system defined in any Feature A-S and any related optional feature(s), as well as a restaurant, kitchen or dark kitchen including the device or system defined in any Feature A-W and any related optional feature(s).

Features A-D: Automated Food Fryer Basket Transport System

We outlined earlier how the Fryr automated food frying system includes an automated basket transport system made up of separate, independent linear movement devices or modules: specifically (see FIG. 6) four separate, independent linear movement devices or modules:
(1) a dispenser transport module 17 that moves an empty basket to a frozen food dispenser and then moves the filled basket away from the dispenser; freezer dispenser transport 17 then transfers the filled basket to:
(2) a link transport module 18, that moves the filled basket up from the food dispenser; vertical link transport 18 then transfers the filled basket to:
(3) a main transport module 19 that moves the filled basket over a well; and then transfers the filled basket to:
(4) a well lifting transport module 20 (one for each well) that moves the filled basket into a well; and then, after the set cooking time, transfers the filled basket back to the main linear transport 19, which in turn moves the filled basket to the food dump.

Then, after the food is deposited into the dump, the main transport module 19 returns the empty basket to the link transport module 18, which lowers the empty basket back down to transfer the basket to the dispenser transport module 17, which (when required) then moves the empty basket under the food dispenser, so that the cycle can begin again.

As noted earlier, a number of benefits flow from there being separate movement systems or modules, each performing a simple, linear motion: Having separate transport modules is advantageous for several reasons.
Firstly, there are several aspects of the frying process which are time critical, such as lifting the product out of the oil when it has completed cooking. Separating the transport systems ensures that they are always available for these time-critical tasks.
Secondly, separate modules allow for independent execution and queuing of tasks, allowing Fryr to achieve the required high throughput.
Finally, by separating each movement into linear actions, Fryr utilises proven and cost-effective technologies that allow for robust and highly-reliable operation. In the event that part of the system does require repair, functions of Fryr can continue to be utilised. For instance if the vertical transport link 18 is unavailable, staff can continue to benefit from the well lifting system 20 controlling cook times, and lessening the criticality of staff interaction timing.

So the Fryr system can simultaneously be frying food in multiple baskets, and can simultaneously be loading a basket with frozen fries at the same time as, for example, another basket is being lowered into a well using well lift mechanism 20, and another basket is being lifted up from another well, using a different well lift mechanism 20 and yet another basket is being moved up and away from the frozen food dispenser by link module 18, and yet another basket is being moved along the main transport 19 to position that basket over an empty well. A computer is of course used to schedule and synchronise all actions, ensuring that scheduled production of fried food is automatically adhered to, and that all SOPs are also automatically adhered to.

We can Generalise to:
Feature A: An automated food-fryer system that is configured to automatically move a food-fryer basket from a food dispenser to a cooking well and then to a food dump; the system including a basket transport system that is made up of several, separate transport modules that are configured to automatically move baskets, and in which the movements (i) between the food dispenser to the cooking well and (ii) down into and up from a cooking well, are independent of, or asynchronous from, each other.
Feature B: An automated food-fryer system that is configured to automatically move a food-fryer basket from a food dispenser, to a cooking well and then to a food dump, the system including a basket transport system that is made up of several, separate transport modules; in which the overall production rate of the system, i.e. the rate at which food batches can be produced by the system, is optimised by a computer-implemented scheduling of basket movement, enabling one or more transport modules to automatically move baskets independently of, or asynchronously from, each other.
Feature C: An automated food-fryer system that is configured to automatically move a food-fryer basket from a food dispenser, to a cooking well and then to a food dump; the system including a basket transport system that is made up of several, separate transport modules; in which the overall production rate of the system, i.e. the rate at which food batches can be produced by the system, is optimised by a computer-implemented scheduling of basket movement, enabling one or more transport modules to automatically queue or buffer baskets with uncooked food until they can be transferred to another transport module.

Optional Features
The transport modules include:
   a dispenser transport module configured to move a basket under different food exits in the frozen food dispenser;
   a link transport module configured to move a basket up and away from the food dispenser;
   a main transport module that extends at least over the frying wells;
   a well transport module configured to lower a basket into a cooking well and raise it up from the well.

We can also generalise to:
Feature D: An automated food-fryer system that is configured to move a food-fryer basket from a position at which it can receive food from a frozen food dispenser to a cooking well; the system including a basket transport system that is made up of several, separate transport modules, including:
   a dispenser transport module configured to move a basket to and away from the frozen food dispenser; and
   a well transport module configured to receive a basket directly or indirectly from the dispenser transport module and to lower the basket into a cooking well and lift it up from the cooking well.

Optional Features (Each is Applicable to all Features)

The Dispenser Transport Module
The dispenser transport module is a linear transport module that enables a basket to be moved solely in the horizontal direction
The dispenser transport module includes a tray on which a basket rests
The dispenser transport module includes a weighing system to weigh the contents of food dispensed into a basket and to enable dispending dynamic or variable weights of food into different baskets
There are multiple food dispensers, and the dispenser transport module is configured to move a basket under a specific food dispenser
The dispenser transport module includes an automatic mechanism configured to grip the basket
The dispenser transport module includes (i) a rail or guide and (ii) a basket support mounted on the rail or guide and moveable along the rail or guide to move a basket on or attached to the support along the rail or guide, to or from the food dispenser
The dispenser transport module is configured to transfer a basket to a link transport module.

The Link Transport Module
The link transport module is a linear transport module that enables a basket to be moved solely in the vertical direction
The link transport module is configured to move a basket up and away from the food dispenser
The link transport module includes a mechanism configured to grip the basket
The link transport module is configured to simultaneously handle multiple baskets.
The link transport module serves as a queue or buffer that can hold filled baskets of uncooked food, waiting for the highest filled basket at the top of the queue to be picked up.
The link transport module includes a moving belt drive that includes multiple attachment points, each shaped for a basket to latch or attach to.
The link transport module is configured to transfer a filled basket to a main transport module that is configured to move the filled basket across to a well.
The link transport module serves as a queue or buffer for the main transport module.

The Main Transport Module
The main transport module extends over the frying wells and the food dump
The main transport module includes a carriage that runs along a horizontal rail or guide that extends over the food dispenser, frying wells and food dumps
The main transport module includes and an automatic mechanism configured to grip a basket
The main transport module includes an extensible arm configured to extend and retract vertically, the arm including an end-effector or gripper configured to grip a basket
The main transport includes a shaker mechanism configured to shake or agitate a basket to minimise food sticking together, and/or to shake excess oil off food in the basket
The main transport module includes a tipping mechanism that is configured to tip or tilt the basket to empty its contents into a dump
The main transport module is configured to transfer the filled basket to a vertical, well transport module
The main transport module is configured to receive or grip a basket with cooked food from a vertical, well transport module

The Well Transport Module
The well transport module is a linear transport module that enables a basket to be moved solely in the vertical direction, down into a well and up from a well
The system includes multiple cooking wells, and there are one, two or more well transport modules for each cooking well.
The well transport module includes a mechanism configured to grip a basket
The well transport module includes a shaker mechanism configured to shake or agitate the basket, whilst the basket is in the well to minimise food sticking together, and/or after the basket has been lifted up from the well to shake excess oil off the food
The well transport module is to transfer a filled basket to the main transport module

Independent Module Operation
The dispenser transport module is configured to move at least one basket at the same time as the well transport module is also moving another basket.
The dispenser transport module is configured to move at least one basket independently of the well transport module moving another basket.
The dispenser transport module is configured to move one or more baskets at the same time as one or more well transport modules are each moving a basket in or out of a well or maintaining a basket in a well.
Each transport module is configured to move at least one basket at the same time as another module is moving another basket.
Each transport module is configured to move at least one basket independently of another module moving another basket.
Each transport module is configured to move at least one basket asynchronously with respect to another module's movement of another basket.
At least one transport module serves as a buffer or queue for baskets that are waiting collection by or transfer to a different transport module.

Movement
Each transport module is configured to move the basket linearly.
The entire basket transport system is underactuated and has only 3 degrees of freedom and is configured to move a basket either vertically or horizontally and to rotate the basket about an axis.
The basket transport system is not a robot with 6 degrees of freedom.
The basket transport system does not require shielding from humans because it is configured with a limited range of movement

The Basket
The basket is a nickel plated wire mesh with a mounting hook configured to enable the basket to be attached to, or gripped by, a corresponding mounting or attachment device on one or more of the transport modules.
The mounting or attachment device is configured to passively hold a standard fry basket in a precisely located position.

The Dispenser
The frozen food dispenser is configured with one or more food compartments that automatically dispense food to a basket based on instructions sent to the system.
The frozen food dispenser is configured with one or more food compartments that are manually accessed and that do not automatically dispense food on demand.
The frozen food dispenser is or includes a freezer, and the waste heat from the freezer is provided to the food dump.
The frozen food dispenser is a wheeled, free-standing unit that is configured to be wheeled out of a casing or shell for the food-fryer system
The frozen food dispenser and the food dump together form a single unit, with the food dump positioned over the frozen food dispenser.

The Food Dump
The food-fryer system includes a food dump that is split into several separate lanes, and the system is configured to automatically select a lane for food to be dumped into, based on the type of food already in that or other lanes, or how long food has been held in that or other lanes.
The food-fryer system is configured to track, for food in the dump, how long a batch of food has been held in the dump or the time elapsed since that batch was removed from the cooking well and to generate an alert when a batch is at its expiry, or is a preset time before expiry.

Air Extraction
The food-fryer system includes an integrated air extraction system.

Hybrid Operation
The food-fryer system is configured to enable a human operator to manually move a basket into and out of any unused wells and to transfer food into the food dump.
The food-fryer system is configured so that the wells and the dump can be manually accessed by a human operator in the event of a failure in the automated operation of the system
The basket transport system is configured to enable a human operator to manually move a basket into the vertical, link transport module

Software Control
A computer implemented software system controls the basket transport system; and the food dispenser that dispenses uncooked food; and the cooking wells.

Cooking Modes
The food-fryer system is configured with multiple different cooking modes, including: Cook on demand; cook to order; cook to learned schedule; and cook to product availability quantity.
The food-fryer system is configured an override cooking mode that sets the production rate at the maximum possible.
The food-fryer system is configured to automatically cook batches of food at a production rate determined a-priori based on learned information about customer behaviour, such as variable environmental factors such as the weather, finish time of local football match, automatically determined measures of restaurant busyness anticipating order requests.
The food-fryer system is configured to automatically cook batches of food at a production rate calculated to be sufficient to provide a pre-set amount of cooked product available in the food dump (the ‘buffer quantity’) and the production rate is closed loop controlled to maintain the amount of cooked product at the buffer quantity as the buffer is depleted by order fulfilment.
An input device, such as a dial or other input controlled by kitchen staff, provides a signal to the food-fryer system to either increase or decrease or maintain the production rate.
The buffer quantity is derived automatically from the restaurant management system that tracks food orders.
The optimal size of the buffer quantity is determined from the current order frequency measured over a time period similar to the cooking time.
The current order frequency is low pass filtered to provide a smoother signal
The current order frequency is coupled with a look ahead calculation based on the rate of change of order frequency so that the buffer quantity responds quickly to a rapid increase in the order frequency.

Personalisation
The food dispenser is configured to automatically dispense a variable weight of food
The first transport module includes a weighing subsystem to weigh the food dispensed into a basket and to stop the dispenser from delivering further food when a required weight of food has been dispensed
The food dispenser is configured to automatically dispense food into a basket in response to a computer implemented schedule that predicts likely demand
the food dispenser is configured to automatically dispense food into a basket in response to an order from a consumer
The food dispenser is configured to automatically dispense an amount or weight of food that is dependent on a consumer defined input
The amount of food is set by a consumer inputting an order for food into an app or website or restaurant management system and the food dispenser automatically receives and processes data related to that order
The consumer defined input covers one or more of: type of food, portion size, amount of salt, amount of specific seasonings.
The basket transport system is configured to move the basket to a salter/seasoner device and to tip or pass the fried food from the basket and into the salter/seasoner device.
Food is one or more of potato chips, vegetable chips, hash browns, any other fried food

Modularity
The dispenser and the dispenser transport module form a single unit that is removeable from the food-fryer system for maintenance and repair
The wells and the well transport module form a single unit that is removeable from the food-fryer system for maintenance and repair

Autopacking System
The food-fryer system includes a packaging system that automatically packages cooked food into individual portions in individual containers or papers, e.g. for food delivery services.
The packaging system is heated
The packaging system includes a salting and/or seasoning system configured to salt and/or season individual portions depending on specific requirements sent from consumers.

Data Connected System
The food-fryer system is configured to track the weight of food dispensed by the food dispenser and the amount of food, including the number of portions packaged, to determine food wastage.
The food-fryer system is configured to use forecast food production schedules to automatically control a base level of operations, including when to dispense food and how much food to dispense.
The food-fryer system is configured to revise its forecast food production schedules using manual input from operators so that the system can learn from the operators.
The fry dump includes a computer vision system to independently track the amount of cooked product available.
The food-fryer system includes APIs to enable external systems to connect to the system.
The food-fryer system is configured to control the operation of the food frying wells.
The food-fryer system is configured to track, for food in the dump, how long a batch of food has been held in the dump or the time elapsed since that batch was removed from the cooking well and to generate an alert when a batch is at its expiry, or is a preset time before expiry.

SOP Compliance
The food-fryer system is configured to automatically record how it performs multiple different types of actions for which a standard operating procedure rule applies to enable automated verification of compliance and automated tracking of non-compliance
Standard operating procedure rules include any of the following:
   Correctly load frying baskets with the correct amount of uncooked food.
   Remove food from the hot oil wells at the correct time
   Drain the food for the correct amount of time
   Minimise the delay between removing food from the fryer and moving to the holding environment or dump
   Season with the correct amount (customised to the quantity of food cooked)
   Ensure that seasoning is distributed over the entire batch of food
   Agitate foods constantly or regularly to prevent pockets of moist air forming
   Guarantee that food is wasted or binned after their quality lifetime is exceeded

Feature E: Automated Salter/Seasoner

The Fryr automated food frying system can automatically salt and/or season fried food, such as fries or chips. It includes an automated salter/seasoner unit positioned next to the fryer; an automated fried food basket transport lifts the fried food basket up from the fryer and tips the fried food into the salter/seasoner unit; the salter/seasoner unit then automatically agitates the food, ensures that the humidity inside the unit is controlled, automatically adds salt/seasoning to the food and then automatically dispenses the required portions. The Fryr automated food frying system enables automated personalisation of a food portion; a diner or customer can now order a required size (e.g. small fries, medium fries or large fries) and also specify the salt amount (e.g. fries with no salt, regular salt, extra salt) and also specify the seasoning type and amount (e.g. fries with regular fry seasoning, fries with extra dried onion seasoning etc.).

We can Generalise as Follows:

An automated salter/seasoner device configured to hold, season and dispense fried food, such as fries or chips; the device including:
(a) a heated, fried food holding container, and an agitator configured to automatically move or agitate the container;
(b) a salt and/or seasoning system configured to automatically dispense salt and/or other seasoning onto the fried food;
(c) a fried food dispenser that is configured to dispense a pre-set portion size or sizes of fried food from the fried food holding container.

Optional Features:

Fried Food Holding Container
Fried food holding container, is a perforated, movable container
Fried food holding container is a rotatable drum
Fried food holding container includes a weight sensor to measure the weight of fried food being held in it
Fried food holding container includes an environment conditioning system for automatically reducing the humidity of the environment in the fried food holding container;

Agitator
The agitator is configured to automatically move or agitate or rotate the container to minimise items of fried food sticking together and/or to ensure sufficient air circulation around the fried food items;
The agitator is configured to automatically move or agitate or rotate the container continuously, intermittently, regularly, or randomly, or any combination of these
The agitator is configured to rotate the drum continuously, intermittently, regularly, or randomly, or any combination of these
The agitator is configured to automatically adjust or change the drum rotation speed
The agitator is configured to automatically move or agitate or rotate the container in a manner that depends on the weight of chips in the fried food holding container

Environment Conditioning System
The device includes an environment conditioning system, such as a dehumidifier,
The environment conditioning system automatically measures the humidity in the fried food holding container and controls humidity reduction based on the measured humidity

Salter or Seasoning System
The salt or seasoning system is configured to automatically dispense salt or other seasoning onto the fried food that is held in the heated fried food holding container
The salt or seasoning system is configured to automatically dispense an amount of salt or other seasoning that is dependent on the amount or weight of fried food in the fried food holding container
The salt or seasoning system is configured to automatically dispense an amount of salt or other seasoning that is dependent on a consumer defined input
The amount of salt and/or other seasoning is set by a consumer inputting an order for food into an app or website and the salter/seasoner device automatically receives and processes data related to that order

Fried Food Dispenser
The fried food dispenser is configured to dispense a pre-set quantity of fried food, on demand, from the fried food held in the agitator.
The demand is manually triggered by a consumer or restaurant staff member
The demand is triggered by a software system based on predicted demand
The fried food dispenser is configured to dispense a portion or quantity of fried food that is consumer-defined
The consumer-defined portion or quantity is set by a consumer inputting an order for food into an app or website and the salter/seasoner device automatically receives and processes data related to that order
Fried food dispenser is configured to automatically discard fried food that has been held in the dispenser for more than a pre-set time.
The pre-set time is a manually set time
The pre-set time is automatically set and is variable, depending on one or more of: measured humidity, or temperature in the agitator or otherwise in the automated salter/seasoner device; the weight or quantity of fried food held in the agitator.
The fried food dispenser dispenses food into a temporary dump, for restaurant staff to manually package
The fried food dispenser dispenses food directly into packaging
Food in the temporary dump or packaging is heated until packing or collection

Context
The automated salter/seasoner device forms part of an automated food-fryer system defined in any preceding Feature or any preceding optional feature.

Feature F: Food Delivery App Integration

The Karakuri automated food frying system automates the entire process of fried food handling, from an initial order from a consumer food delivery app to producing the ordered portions of food, e.g. ready for collection. This ensures the freshest possible food. An order into a food delivery app is sent to the automated food-fryer system, which then determines how best to service that order to meet the applicable standard operating procedure rules, including the time from food being placed into the food dump to it being collected. There are essentially two scenarios: first, the system determines that a fresh batch of food should be cooked, and it then triggers the food dispenser to release food into a basket; the entire sequence is as described in Feature A-D. Secondly, the system identifies a batch of food that is already being processed (e.g. being moved from the dispenser, or in a cooking well, or in the food dump) and associate that batch with the new order.

We can Generalise to:

A food preparation system configured to receive an order from a food delivery app, and to automatically determine how to service that order to meet applicable standard operating procedure rules, including selecting from the following options: (a) to instruct an automated food-fryer system to prepare a new batch of food to meet the order; (b) to identify a batch of food currently being processed in the automated food-fryer system and to associate that batch with the order.

Optional Features
The automated food-fryer system is controlled to start the food frying process at a time selected to so that the food is ready at an optimal time, e.g. collection by a food delivery driver/rider or the consumer, ready when other food items are ready (e.g. esp. other food items that take longer to cook).r
A food dispenser in the automated food-fryer system is configured to automatically dispense an amount of food that is dependent on a consumer defined input
The amount of food is set by a consumer or restaurant staff inputting an order for food into the application
The automated food-fryer system includes an automated salter/seasoner device configured to hold, season and dispense fried food
The salter/seasoner device includes a salt or seasoning system that is configured to automatically dispense an amount of salt or other seasoning that is dependent on a consumer defined input entered into the food delivery app.
The amount of salt or other seasoning is set by a consumer inputting an order for food into the food delivery app.
The system is configured to optimise the quality and availability of fried food from the automated food-fryer system by a software control system taking into account one or more of: (a) the quantity of food being fried in the deep fat fryer(s); (b) the quantity of food held in the automated salter/seasoner device; (c) the expected dispensing or collection time for one or more portions of food held in the automated salter/seasoner device.
The automated food-fryer system is configured to feedback the amount of fried food currently being held in the dump or an automated salter/seasoner device and the rate it is being removed, to improve forecasting accuracy for the availability of fried food.
The system includes any feature defined in any preceding Feature or any preceding optional feature.

Feature G: Chip Frying System with User-Defined Chip Crispness

Currently, fried products are cooked in a uniform manner across batches. This is due to the disconnect between batches and orders i.e. a specific batch of product is not linked to a specific order, but is cooked and dumped on a generic basis. The Fryr automated food frying system automates the entire process of fried food handling, from an initial order for e.g. a portion of fries from a consumer food delivery app, down to the final salting and seasoning of that portion of fries. By enabling fryers to cook smaller batches more frequently, e.g. to customer order, the Fryr system enables product to be cooked to a specific level specified by the customer. By varying oil temperature and/or time, product could be produced with varying ranges of crispness, etc.

Because the system can vary the cooking time and oil temperature for each individual basket placed in the fryer, consumers can now specify how crisp they would like their fries; for example, frozen chips fried at 350 F for 5 minutes will be crispier and browner than chips fried for 3 minutes at the same temperature, or a lower temperature. Whilst diners have for years been able to have their meat cooked to their preference (e.g. rare, medium-rare etc.), the Karakuri automated food frying system now enables the same degree of control and customisation for chips, e.g. on a portion by portion basis. Also, the system can also automatically double (or triple) cook fries (to order or as the standard technique); this involves frying once at below 350 F (to soften the potato), and then a second (or third) fry at 350 to get a crispy exterior.

We can Generalise to:

An automated chip-fryer system including a chip-fryer basket transport system that is configured to move a food-fryer basket (i) down into a deep fat fryer that fries one or more portions of chips in the basket for a pre-set cooking time at a pre-set cooking temperature; (ii) up from the deep fat fryer when that pre-set time has elapsed; in which the system includes an interface that controls the pre-set cooking time and/or pre-set cooking temperature;
and the interface enables a user to vary and also to select or input at least one of the following in order to customise the chips to an individual consumer's preference: the pre-set cooking time; the pre-set cooking temperature; the degree of crispness of the chips; the extent of cooking of the chips.

Optional Features
The interface enables a user to select whether one or more portions of chips are regular or well done/crispy, or substantially equivalent.
The interface enables a user to select whether one or more portions of chips are light, or regular, or well done/crispy, or substantially equivalent.
The interface is an in-restaurant interface configured for kitchen or serving staff or in-restaurant or take-away diners to select or input different pre-set times, degrees of crispness of the chips, or extent of cooking of the chips
The interface is a food delivery or food service application operated by a consumer and configured for the consumer to select or input different pre-set times, degrees of crispness of the chips, or extent of cooking of the chips they are ordering.
The system includes any feature defined in any preceding Feature or any preceding optional feature.

Feature H: Predictive Setting of Oil Temperature in a Deep Fat Fryer, Depending on Anticipated Future Usage

In conventional food frying systems, a thermometer measures the temperature of the cooking oil in the deep fat fryer and aims to keep that oil at an optimal deep frying temperature of about 180 C or 350 F when cooking food; a simple thermostat system is used, so that if the temperature of the cooking oil drops significantly below 350 F, then the power to the heating element (if an electrical heating system is used) or the volume of gas (if gas burners are used) is increased until 350 F operating temperature is reached.

When frozen food is lowered into a deep fat fryer with oil at 350 F, the temperature of the oil drops, and the thermostat turns up the gas burners or power to the heating element until the oil is back at 350 F. But this can take 30 seconds or more, and during that time, the food is being cooked at a sub-optimal temperature and as a result, can be soggy as excessive oil has been absorbed; when restaurants are very busy and cooking a lot of frozen fried food, the quality of the fried food can hence be quite poor. Most deep fat fryers are calibrated to recognise a minimum 20 F change in the oil temperature, but not smaller temperature changes, so further increasing the time for the system to react. Some systems attempt to compensate for lower cooking temperatures by extending the cooking time, but the results are still poor since the food will still have absorbed excessive oil during the time the oil was below the optimal cooking temperature at which a crisp outer coating forms (as driven by the Maillard reaction).

Conversely, when restaurants are very quiet, a lot of energy can be wasted by keeping the cooking oil at 350 F; sometimes, restaurants will manually lower the temperature of the deep fat fryers during quiet periods, but it can take several minutes to raise the temperature back up to 350 F and so customers during those quiet periods can have to wait longer than normal, or else have food that was cooked (at least initially) in oil that was under-temperature, with poor quality results.

The Karakuri automated food frying system can raise the cooking oil temperature above the normal cooking temperature. It can raise the cooking oil temperature above the normal cooking temperature automatically, for example, because it knows when frozen food is about to be placed into the oil since data from the frozen food dispenser can be used to control the deep fat fryer thermostat: when the frozen food dispenser delivers weight Xg of frozen food into the automated deep fat fryer basket, then a control system increases the thermostat temperature so that, given that weight Xg of frozen food, and the thermal mass of the oil, the oil temperature will drop to the normal cooking temperature within a short time period when the basket with that frozen food is lowered into the oil (i.e. not so long that the food can burn or over-cook).

The Karakuri system can raise the cooking oil temperature above the normal cooking temperature automatically if it is connected to food or meal ordering software—e.g., the software that a waiter, server or customer enters a food or meal order into, or a meal delivery app that the remote customer enters a food or meal order into. Once the order is received, the Karakuri system not only starts preparing the meal, but also advance heats the oil in the deep fat fryer; the extent of heating can be a function of one or more of: the quantity of the food to be cooked, the type of food to be cooked, its thermal mass, the thermal mass of the cooking oil and its frozen or chilled temperature.

There are other circumstances where the Karakuri automated food frying system can automatically raise the cooking oil temperature above the normal cooking temperature: for instance, at certain times in the evening (e.g. when pubs close), the system can be set to automatically raise the cooking oil temperature, in anticipation of a large number of orders.

It can also do this manually—for example, the system could include a button or other control, that when manually pressed or selected, boosts the temperature of the oil above the normal 350 F; a cook can then press or select the control when he or she becomes aware that say one basket of chilled or frozen food will shortly be placed into the deep fat fryer.

Advanced or pre-emptive excess or additional heating of the cooking oil enhances the quality of the fried food because it reduces the risk of frozen or chilled food dropped into the cooking oil lowering the temperature of the cooking oil so that the outer surface of the food absorbs oil instead of sealing and cooking. This approach reduces the chance of over/undercooking, and enables a more predictable and uniform cooking time.

Another advantage is that the additional power (e.g. gas or electric) needed for advanced or pre-emptive heating can be less than the additional power needed in a conventional system; in the conventional system, if the oil temperature drops to say 250 F when a large quantity of frozen food is placed in the oil, then very high capacity gas burners or a very high capacity electrical heating element is needed, since it is critical to get the temperature of the oil back up to 350 F as quickly as possible. But in the Karakuri system, less powerful gas burners or electrical heating elements are needed, since there is no longer any need to intensely heat the oil back up to 350 F.

Since the Karakuri system knows if no frozen food is being dispensed for deep fat frying, and/or that no fried food has been ordered by a consumer or waiting staff, it can also automatically lower the cooking oil temperature below the normal cooking temperature, e.g. to an idle mode temperature. It can do so not only if no cooking of frozen or chilled food has been scheduled, but also during generally quiet times (which can be manually input into the system, or learnt by the system over time).

We can Generalise to:

An automated food-fryer system configured to deep fry food at an optimal or desired temperature, and configured to automatically raise the temperature of cooking oil above the optimal or desired cooking temperature prior to frozen or chilled food being deposited into the cooking oil.

Optional Features
The automated food-fryer system is configured to automatically raise the temperature of cooking oil based on a predictive schedule of user demand.
The automated food-fryer system is configured to automatically raise the temperature of cooking oil above the normal cooking temperature by an amount that depends on a predicted or expected weight or quantity of frozen or chilled food that is to be cooked in the oil.
The automated food-fryer system includes or is connected to a frozen or chilled food dispenser and that dispenser informs the food-fryer system if frozen or chilled food has been dispensed or is scheduled to be dispensed.
A weighing system weighs the frozen or chilled food dispensed from the food dispenser
The weighing system provides data to the food-fryer system so that the food-fryer system can calculate the amount by which the temperature is to be raised.
The weighing system directly weighs the food from the food dispenser or indirectly infers its weight using a computer vision system that determines the quantity or amount of the food, or the level of the food in a food container.
The automated food-fryer system includes or is connected to an in-restaurant food or meal ordering system.
The automated food-fryer system is connected to a food or meal ordering and delivery app.
The automated food-fryer system is configured to raise the temperature of cooking oil above the normal cooking temperature by an amount that depends on data from the food or meal ordering and delivery app.
The automated food-fryer system is configured to raise the temperature of cooking oil above the normal cooking temperature by an amount that depends on one or more of: the quantity of the food to be cooked, the type of food to be cooked, its thermal mass and its frozen or chilled temperature.
The automated food-fryer system is configured to raise the temperature of cooking oil above the normal cooking temperature at times of predicted high demand.
The automated food-fryer system is configured to predict times of high demand and to automatically raise the temperature of cooking oil above the normal cooking temperature prior to those predicted times of high demand.
The automated food-fryer system is configured to raise the temperature of cooking oil above the normal cooking temperature under manual control.
The automated food-fryer system is configured to automatically lower the temperature of the oil to below the normal cooking temperature.
The automated food-fryer system is configured to automatically lower the temperature of the oil to below the normal cooking temperature when no fried food orders have been received for a pre-set time.
The automated food-fryer system is configured to predict times of low demand and to automatically lower the temperature of cooking oil below the normal cooking temperature prior to or at those predicted times of low demand.
The system includes any feature defined in any preceding Feature or any preceding optional feature.

Feature I: Maintaining Oil Temperature in a Deep Fat Fryer, by Varying Heat Input Depending on Food Batch Size

In Feature E above, we have seen how the Karakuri system can pre-emptively heat the oil to above the target cooking temperature by an amount that depends on a predicted or expected weight or quantity of frozen or chilled food that is to be cooked in the oil. One generalisation of this is for the Karakuri system to heat the oil to a temperature that depends on a predicted or expected weight or quantity of frozen or chilled food that is to be cooked, and for that temperature not to be above an target cooking temperature. For example, when cooking small batches of frozen food, it may be appropriate to heat the oil to just the normal cooking temperature prior to the frozen food; for larger batches, it may be appropriate to heat the oil to the same normal cooking temperature, but to then increase the heat supplied (e.g. turn up the gas burners) when the food is lowered into the deep fryer to maintain that oil temperature.

So, Feature E covers pre-emptively heating the oil to higher than the target cooking temperature before the food is lowered into the fryer, and this Feature F covers heating the oil to the target cooking temperature before the food is lowered into the fryer, and then increasing the heat applied to the fryer as the food is added in order to maintain that target cooking temperature. The amount of extra heat may depend on the amount of food being fried; the Karakuri system knows the amount and weight (and thermal mass) of the food being dispensed into the basket that will be moved across and lowered into the fryer and uses this data to determine the appropriate amount of extra heat needed to maintain the oil at the desired temperature (i.e. within a specific margin of error, perhaps 5 degrees C.)

This approach reduces the chance of over/undercooking, and enables a more predictable and uniform cooking time.

We can Generalise to:

An automated food-fryer system configured to deep fry food at an optimal or desired temperature, and configured to raise the heat or energy supplied to the food-fryer when frozen or chilled food is deposited into the cooking oil by an amount automatically calculated to maintain the temperature of cooking oil at the optimal or desired cooking temperature as the frozen or chilled food is added into the cooking oil.

Optional Features
The automated food-fryer system is configured to raise the heat or energy supplied to the food-fryer when frozen or chilled food is deposited into the cooking oil by an amount that depends on a predicted or expected weight or quantity of frozen or chilled food that is to be cooked in the oil.
The automated food-fryer system includes or is connected to a frozen or chilled food dispenser and that dispenser informs the food-fryer system if frozen or chilled food has been dispensed or is scheduled to be dispensed.
A weighing system weighs the frozen or chilled food dispensed from the food dispenser
The weighing system provides data to the food-fryer system so that the food-fryer system can calculate the amount by which the heat or energy supplied to the food-fryer is to be raised.
The weighing system directly weighs the food from the food dispenser or indirectly infers its weight using a computer vision system that determines the quantity or amount of the food, or the level of the food in a food container.
The automated food-fryer system includes or is connected to an in-restaurant food or meal ordering system.
The automated food-fryer system is connected to a food or meal ordering and delivery app.
The automated food-fryer system is configured to raise the heat or energy supplied to the food-fryer when frozen or chilled food is deposited into the cooking oil by an amount that depends on one or more of: the quantity of the food to be cooked, its thermal mass and its frozen or chilled temperature.
The automated food-fryer system is configured to raise the heat or energy supplied to the food-fryer at times of predicted high demand.
The automated food-fryer system is configured to predict times of high demand and to automatically raise the heat or energy supplied to the food-fryer prior to those predicted times of high demand.
The automated food-fryer system is configured to raise the heat or energy supplied to the food-fryer under manual control.
The automated food-fryer system is configured to automatically lower the temperature of the oil to below the normal cooking temperature.
The automated food-fryer system is configured to automatically lower the temperature of the oil to below the normal cooking temperature when no fried food orders have been received for a pre-set time.
The automated food-fryer system is configured to predict times of low demand and to automatically lower the temperature of cooking oil below the normal cooking temperature prior to or at those predicted times of low demand.
The system includes any feature defined in any preceding Feature or any preceding optional feature.

Feature J: Automated Start and End of Fryer Idle Mode Based on Scheduling of Next Food Order

In order to reduce energy usage and increase oil lifetime (by holding the oil at a more optimal temperature), some conventional food fryers enter an idle mode after a specified period of time, during specified time periods, or from manual input via a button. In idle mode, the fryer holds the oil at a temperature lower than the cooking temperature.

By utilising knowledge of when batches of product are about to be cooked, the Karakuri system automatically enters idle mode earlier, based on the finish cooking time of the current batch in the fryer, and the start time cooking time for the next batch of food. For example, it may be that starting idle mode 20 seconds before the end of the cooking time for a basket of fries has no impact on the quality of the fries; if no further batches of food are scheduled for imminent frying, it may make sense to enter idle model 20 seconds earlier (or some other time found through experimentation to be appropriate; this time will likely vary with the type of food been fried and the quantity of food being fried). This can save considerable amounts of energy over the course of a normal day.

Increasing throughput is then possible, by removing the waiting time otherwise required to allow the fryer to heat from its idle temperature to its cooking temperature (which can occur during dispensing of the frozen product), and reducing the time product may spend thawing before being put into the fryer.

Further, fryers have a limited capacity rate for inputting heat into the oil; it can take 30 seconds or more to heat the oil from idle mode to the desired operating temperature. Because the Karakuri system knows if and when the next order of food has been accepted (e.g. at a restaurant POS or ordering system) or is actually being dispensed (e.g. from the frozen fries dispenser) it knows when, ideally, the oil needs to reach operating temp from idle mode and can hence start heating the oil from idle mode in advance of the frozen food reaching the food fryer.

For example, the fryer could also end idle mode and to begin preheating the oil as soon as the request for chips is placed. Alternatively, if it takes 30 seconds to heat the oil from idle mode temperature to the desired target temperature, and it takes the Karakuri system 45 seconds from starting to dispense a portion of frozen fries into a food basket, and to move that food basket from the dispenser to the food fryer and to start lowering the food basket into the fryer, then the Karakuri system takes the food fryer out of idle mode 15 seconds after the frozen fries start to be dispensed. This enables more frequent use of idle mode, without exceeding the heating capacity rate of the fryer or frying food in below temperature oil. Increasing throughput is then possible, by removing the waiting time otherwise required to allow the fryer to heat from its idle temperature to its cooking temperature (which can occur during dispensing of the frozen product), and reducing the time product may spend thawing before being put into the fryer.

We can Generalise to:

An automated food-fryer system configured to deep fry food in an optimal or desired temperature cooking mode, and to have an energy conserving idle mode;
and to automatically enter idle mode based on the predicted finish cooking time of a current batch of food in the fryer; and to automatically leave idle mode based on the start time cooking time for a next batch of food.

Optional Features
The system automatically calculates the finish cooking time of a current batch of food in the fryer
The system automatically calculates the start time cooking time for the next batch of food
The automated food-fryer system includes or is connected to a frozen or chilled food dispenser and that dispenser informs the food-fryer system if frozen or chilled food has been dispensed or is scheduled to be dispensed.
A weighing system weighs the frozen or chilled food dispensed from the food dispenser
The weighing system provides data to the food-fryer system so that the food-fryer system can calculate when to leave idle mode.
The weighing system directly weighs the food from the food dispenser or indirectly infers its weight using a computer vision system that determines the quantity or amount of the food, or the level of the food in a food container.
The automated food-fryer system includes or is connected to an in-restaurant food or meal ordering system.
The automated food-fryer system is connected to a food or meal ordering and delivery app.
The automated food-fryer system is configured to calculate when to leave idle mode based on one or more of: the quantity of the food to be cooked, its thermal mass and its frozen or chilled temperature.
The automated food-fryer system is configured to automatically leave idle mode at times of predicted high demand.
The automated food-fryer system is configured to predict times of high demand and to automatically leave idle mode prior to those predicted times of high demand. The automated food-fryer system is configured to leave idle mode under manual control.
The automated food-fryer system is configured to automatically enter idle mode when no fried food orders have been received for a pre-set time, or no food is scheduled to be fried for a pre-set time.
The automated food-fryer system is configured to predict times of low demand and to automatically enter idle mode at those predicted times of low demand.
The system includes any feature defined in any preceding Feature or any preceding optional feature.

Feature K: Automated Triggering of Oil Filtering Based on Fryer Throughput

In conventional food fryers, the oil is occasionally filtered to remove impurities: this is done manually and is often miss-timed and performed too late to protect the oil. In the Karakuri system, the oil is automatically and regularly filtered; the timing of this filtration is based on the throughput (e.g. one or more of: weight of food cooked; number of cooking cycles; type of food cooked; type of oil used; whether the oil was ever heated to an excess temperature; temperature profile of the oil—in essence, any variable that the system records and could also affect the quality of the oil and hence whether it needs to be filtered or not). This increases oil life and reduces oil waste.

We can Generalise to:

An automated food-fryer system configured to deep fry food in oil and to automatically filter the oil;
in which the system (i) records one or more parameters that affect the quality of the oil and (ii) automatically starts an oil filtration process depending on the value of the parameter(s).

Optional Features
The parameter is the weight of food cooked;
the parameter is number of cooking cycles
The parameter is the type of food cooked
The parameter is the type of oil used;
The parameter is whether the oil was ever heated to an excess temperature;
The parameter is temperature profile of the oil
The system includes any feature defined in any preceding Feature or any preceding optional feature.

Feature L: Computer Vision System to Identify Floating Debris in the Fryer Oil

During the frying process, there is a build-up of floating crumbs and other debris which eventually burn and spoil the taste of the oil. This debris is normally just manually skimmed from the top of the oil. In the Karakuri system, there is a computer vision system which observes the debris content; the computer vision system includes an AI engine trained to interpret the images and assess whether the level of debris is sufficient to trigger an alert; the alert can be a signal for a manual skim, or it can initiate an automated system for skimming and disposing of the debris.

We can Generalise to:

An automated food-fryer system configured to deep fry food in oil; in which the system includes a computer vision system generating images of the oil and an AI engine trained to interpret the images and to assess whether the level of any debris in the oil is sufficient to trigger an alert.

Optional Features
The alert is a manual alert
The alert initiates an automated system for skimming and disposing of the debris
the system includes any feature defined in any preceding Feature or any preceding optional feature.

Feature M: Automated Control of Different Wells in a Multi-Well Fryer Based on Incoming Food Orders

With a conventional multi-well fryer, it is normal to operate all wells at the same time. The Karakuri system is capable of automatically determining the fryer throughput capacity required, based on the number of orders being received or predicted, and hence can automatically determine how many wells to heat. It is possible to make significant energy savings and extend oil life by only operating the wells that are required at the time. Depending on the predicted throughput of food to fry, some or all of the wells can be turned completely off, or heated to an idle mode temperature, or heated to normal operational temperature.

We can Generalise to:

An automated multi-well food-fryer system configured to deep fry food in oil; in which the system is configured to automatically control how many wells are heated depending on the predicted throughput of food to be fried.

Optional Features
Some or all of the wells are turned completely off
Some or all of the wells are heated to an idle mode temperature
Some or all of the wells are heated to normal operational temperature.
The automated food-fryer system includes or is connected to a frozen or chilled food dispenser and that dispenser informs the food-fryer system if frozen or chilled food has been dispensed or is scheduled to be dispensed so that the system can automatically determine the predicted throughput.
A weighing system weighs the frozen or chilled food dispensed from the food dispenser
The weighing system provides data to the food-fryer system so that the food-fryer system can automatically determine the predicted throughput.
The weighing system directly weighs the food from the food dispenser or indirectly infers its weight using a computer vision system that determines the quantity or amount of the food, or the level of the food in a food container.
The automated food-fryer system includes or is connected to an in-restaurant food or meal ordering system.
The automated food-fryer system is connected to a food or meal ordering and delivery app.
The automated food-fryer system is configured to heat all wells at times of predicted high demand.
The automated food-fryer system is configured to predict times of high demand and to automatically heat all wells prior to those predicted times of high demand.
The automated food-fryer system is configured to heat one or more wells under manual control.
The automated food-fryer system is configured to automatically lower the temperature of the oil to below the normal cooking temperature.
The automated food-fryer system is configured to automatically lower the temperature of the oil to below the normal cooking temperature when no fried food orders have been received for a pre-set time.
The automated food-fryer system is configured to predict times of low demand and to automatically lower the temperature of cooking oil below the normal cooking temperature prior to or at those predicted times of low demand.
The system includes any feature defined in any preceding Feature or any preceding optional feature.

Feature N: An Automated Food Fryer System for Agitating Frying Baskets to Separate Fries from Each Other when Immersed in Oil to Ensure they are Evenly Cooked.

Conventional food fryer systems have to be regularly manually shaken by an operator to separate fried food to stop them sticking together and cooking unevenly. But in a busy kitchen, this can easily get overlooked. The Karakuri system includes an automatic basket shaker mechanism that shakes the basket at pre-set time intervals, or at time intervals that depends on the amount of food in the basket (a very full basket will be shaken more frequently than a nearly empty basket).

We can Generalise to:

An automated food-fryer system configured to deep fry food in oil; in which the system includes (i) a food-fryer basket; (ii) a device configured to automatically lower the basket into an oil well in the deep fat fryer and to raise it up from the fryer; and (iii) a device configured to automatically agitate the basket whilst it is lowered in the oil well.

Optional Features
The device automatically agitates the basket at pre-set time intervals,
The device automatically agitates the basket at time intervals that depends on the amount of food in the basket
The device automatically agitates the basket for a pre-set amount of time
The device automatically agitates the basket for an amount of time or in a manner that depends on the amount of food in the basket
A very full basket is shaken more frequently and/or vigorously than a nearly empty basket.
The automated food-fryer system includes or is connected to a frozen or chilled food dispenser and that dispenser informs the food-fryer system of the amount of food in the basket
A weighing system weighs the frozen or chilled food dispensed from the food dispenser
The weighing system provides data to the food-fryer system so that the food-fryer system can automatically determine the amount of food in the basket.
The weighing system directly weighs the food from the food dispenser or indirectly infers its weight using a computer vision system that determines the quantity or amount of the food, or the level of the food in a food container.
The system includes any feature defined in any preceding Feature or any preceding optional feature.

Feature O: An Automated Food Fryer System to Rapidly Remove Excess Oil Through from Fried Food Following Removal from the Fryer

In a conventional food fryer system, when a basket with fried food is lifted up from the heated oil, it is vigorously shaken by an operator to rapidly remove excess hot oil. But this is process inconsistent and in a busy kitchen, can be overlooked. The Karakuri system includes an automatic basket shaker mechanism that shakes the basket after it has been lifted up from the hot oil.

We can Generalise to:

An automated food-fryer system configured to deep fry food in oil; in which the system includes (i) a food-fryer basket; (ii) a device configured to automatically lower the basket into an oil well in the deep fat fryer and to raise it up from the fryer; and (iii) a device configured to automatically agitate the basket after is has been raised up from the oil well.

Optional Features
The device automatically agitates the basket for a pre-set amount of time
The device automatically agitates the basket for an amount of time that depends on the amount of food in the basket
The device automatically agitates the basket with a force that depends on the amount of food in the basket
A very full basket is shaken more frequently and/or with greater force than a nearly empty basket.
The automated food-fryer system includes or is connected to a frozen or chilled food dispenser and that dispenser informs the food-fryer system of the amount of food in the basket
A weighing system weighs the frozen or chilled food dispensed from the food dispenser
The weighing system provides data to the food-fryer system so that the food-fryer system can automatically determine the amount of food in the basket.
The weighing system directly weighs the food from the food dispenser or indirectly infers its weight using a computer vision system that determines the quantity or amount of the food, or the level of the food in a food container.
The system includes any feature defined in any preceding Feature or any preceding optional feature.

Feature P: Automated Food Fryer System with Automatic Fryer Well Covers

One of the main drivers of power consumption in deep fat frying are the heat losses (e.g. convective; radiative) from the hot oil to the atmosphere. The Karakuri food fryer system covers the ‘open’ basket fryer with a thermally insulated cover containing a door (or an airlock) through which the basket or frozen food travels. This allows the air above the fry wells to be contained, thereby breaking the convection cycle to the kitchen atmosphere. This has the benefits of reducing convective losses to the atmosphere, reducing the energy consumption of the fryer and also reducing the need for air extraction power, further increasing the energy savings.

A cover also has the benefit of reducing the potential for human contact with hot oil and hence improving safety and the working environment around the fryer. The cover is openable to enable manual override during operation, cleaning and maintenance of the system. The energy saving and safety benefits of such a covered system are only realisable if all the elements of the frying process are automated, effectively by implementing many of the features described in this document, thereby enabling the cover to remain closed during normal food frying operation.

An additional benefit of being able to control the air above the fry wells is to maintain a temperature and humidity controlled consistent sealed air path from the end of the frying process through to the seasoner and to the final dispenser. This improves the quality of food and extending its hold time by removing an uncontrolled cooling/heating cycle that occurs in a conventional process as the fries are removed from the fryer in an open, uncontrolled, cool, potentially humid atmosphere before seasoning and holding.

We can Generalise to:

An automated food-fryer system with one or more wells configured to contain heated oil for deep frying food, in which the system is configured with a cover system to automatically close over one or more of the wells during normal frying operation to reduce heat loss from the heated oil and to automatically open when access to a well is required.

Optional Features
The food-fryer system includes a food basket that is lowered into a well to fry food in the basket and then raised up and out of the well when frying is completed, and the cover system is positioned above the well and opens automatically to allow the basket to be moved into the well and closes automatically once the basket is positioned in the well.
The food-fryer system includes a food basket that is lowered into a well to fry food in the basket and then raised up and out of the well when frying is completed, and the cover system is positioned above the well and also above the food basket when the food basket is raised up and out of the well.
The food-fryer system includes a food basket that is lowered into a well to fry food in the basket and then raised up and out of the well when frying is completed, and also include a basket transport mechanism that automatically moves the food basket from a food dispenser to the well, and the cover system is positioned above the well, above the food basket when the food basket is raised up and out of the well and also above the basket transport mechanism.
The food-fryer system includes a salter/seasoner unit, and the cover system covers the well and at least part of the salter/seasoner unit.
The cover is thermally insulated
The cover is reflective to radiant heat
The cover includes an airlock through which a food basket is configured to move
The cover is openable to enable manual override during operation, cleaning and maintenance of the system
The system includes any feature defined in any preceding Feature or any preceding optional feature.

Feature Q: Automated Portion Packaging System

The Fryr system includes an automated packaging system that takes freshly cooked food, e.g. from the food dump, and automatically packages the food into single portions (e.g. in cardboard or paper) e.g. for food delivery services. The automated packaging system tracks the number of portions packaged, when they were produced and other related data (e.g. an order number uniquely identifying each portion, when the order was placed, how long it took to complete the order, when the order was collected). The automated packaging system can include the seasoning unit described in Feature B. The portioning compartment and storage area for packed product is heated. This means that a hot chain from fry well through to packing and holding can be guaranteed, for the best possible quality.

We can Generalise to:

An automated food-fryer system that is configured to fry batches of food, in which the system includes a packaging system that automatically packages cooked food into individual portions, each in individual containers or papers.

Optional Features
The packaging system is heated
The packaging system includes a salting and/or seasoning system configured to salt and/or season individual portions depending on specific requirements sent from consumers.
The system includes any feature defined in any preceding Feature or any preceding optional feature.

Feature R: Modular Food Fryer System

The Fryr system is made up of separate modules that each fit into a large casing. There are two main modules:
The food dispenser and the dispenser transport module form a single unit that is removeable from the food-fryer system for maintenance and repair
The cooking unit, including the frying wells, and the well transport module form a single unit that is removeable from the food-fryer system for maintenance and repair

The main linear transport 19 and the fry well lifting transport 20 remain in the main body of the Fryr system.

We can Generalise to:

An automated food-fryer system that includes (a) a food dispenser and a dispenser transport module, for moving fryer baskets to and from the food dispenser, that together form a single unit that is removeable from the food-fryer system for maintenance and repair; and also includes (b) a cooking unit, including frying wells, and a well transport module for moving baskets into the wells, that together form a single unit that is removeable from the food-fryer system for maintenance and repair.

Optional Features
The automated food-fryer system includes a casing or walled enclosure in to which the food dispenser, and the dispenser transport module, and the cooking unit, and the well transport module, are configured to fit into.
The system includes any feature defined in any preceding Feature or any preceding optional feature.

Feature S: Hybrid Automated and Manual Food Fryer System

The Fryr device is fully automated and requires no regular human intervention, other than filling the dispensers with frozen food and collecting cooked food from the food dump 5. In addition, as noted earlier, it also enables kitchens staff to manually insert a basket (e.g. with food not available from the food dispenser, e.g. frozen or other food not stored in the automatic food dispenser 1) into the system and for the system to then cook the food correctly. This also enables the use of baskets that differ from the standard chip fryer basket, which is essentially an empty, nickel-plated wire mesh container: for example, the fryer baskets for hash browns and tacos usually have multiple internal rows of mesh, to better support the hash browns and tacos and ensure even cooking.

As described earlier, the Fryr device includes a manual basket inlet 23 (see FIG. 1) and shown also in FIG. 8. An operator is able to load a fryer basket 4 with food and to push the basket onto rails that lead into the inlet 23, to engage with vertical link transport 18, which picks up the basket, and lift it to main linear transport 19; the rest of the cooking and dumping process is as before.

We can Generalise to:

An automated food-fryer system that includes an automated basket transport system configured to automatically move a fryer basket from under a food dispenser and into a frying well without any human operator interaction, and further includes (a) a manually operated or accessed inlet or opening configured to enable a human operator to manually move a basket into and out of any unused wells and (b) a manually operated or accessed inlet or opening configured to enable a human operator to manually move a basket so that it engages with the automated basket transport system.

Optional Features
The basket transport system is configured to enable a human operator to manually move a basket into and out of any unused wells.
The basket transport system is configured to enable a human operator to manually move a basket into the vertical, link transport module
The system includes any feature defined in any preceding Feature or any preceding optional feature.

Feature T: Automated Food Fryer System with Operations Scheduled Using a Genetic Algorithm

The Fryr automated food-fryer system cooks food automatically, following optimised cook schedules that have been generated by a Genetic Algorithm (GA). The inputs to the GA are the Fryer Transactions (e.g. timed data tracking all events in the system), SOPs and the physical limitations of the frying process (e.g. well configuration, oil management etc). The GA takes these inputs, generates candidate cook schedules and scores these schedules based on how many fried product orders are met and how much waste for each product is generated. The best candidates are then selected and mutations (e.g. adjusting batch size or cook start time) are applied to each to generate a new set of candidate schedules taking features from the best. This process is repeated until an optimised cook schedule is found.

In this way we are able to generate cook schedules which fulfil orders strictly within SOP, and take into account all the physical limitations of the frying process (well configuration, oil management etc) whilst also minimising waste. We use a Genetic Algorithm due to the inherent nonlinearity of the problem, that is, optimising cook schedules for multiple fried products with different physical constraints (cook times, hold times, batch sizes).

We can Generalise to:
An automated food-fryer system including a food dispenser configured to automatically dispense food into a fryer basket in response to a computer implemented schedule that predicts likely demand, in which the schedule has been designed using a genetic algorithm for which the training inputs include: fryer transaction data, standard operation procedure requirements, and the physical parameters of the frying equipment, including the number of wells.

Optional Features
The system includes any feature defined in any preceding Feature or any preceding optional feature.

Feature U: Automated Food Fryer System that Tracks Counts the Number of Portions Delivered

The Fryr system is a data connected system in which all operations are tracked and timed. This data is used, for example, to understand wastage levels and to enable a cross-check between the numbers of portions of different types of food actually sold (e.g. tracked by the restaurant sales software) and the number of portions of those foods actually made and also the number of portions of those foods actually packaged up or plated into portions for a consumer. Discrepancies can indicate food wastage, fraud, or system failures.

We can Generalise to:

An automated food-fryer system including a portion counting system configured to (i) count the number of portions of different types of food ordered, (ii) count the number of portions of those different types of foods actually packaged up or plated into individual portions for a consumer.

Optional Features
The portion counting system is configured to count or infer the number of portions of different types of food actually made
The food-fryer system is configured to track the weight of food dispensed by the food dispenser and the amount of food, including the number of portions packaged, to determine food wastage.
The system includes any feature defined in any preceding Feature or any preceding optional feature.

Feature V: Automated Food Fryer System that Tracks and Times Operations to Enable Compliance with SOPs to be Verified

The Fryr system is a data connected system in which all operations are tracked and timed. For instance, every incoming order (e.g. from a restaurant POS system, or consumer food delivery app) to the system is tracked and timed; the time and amount of frozen food dispensed from the freezer is tracked and timed; the operation of the transport system in moving the food fryer basket to the frying wells is tracked and timed; the duration of frying time is tracked and timed; the operation of the transport system in moving the food fryer basket up from the frying well and to the holding area is tracked and timed; the time that a batch of food from a specific fryer basket is kept in the holding area is tracked and timed; the time at which each individual portion of food from that batch is packaged or plated, or discarded if out of time, is tracked and timed; the time at which each individual portion of food is collected is tracked and timed. This data richness is used in the automated assessment of compliance with SOPs, and where non-compliance is identified, that leads to changes in food handling processes to improve SOP compliance, leading to better quality product, with less waste.

The Fryr device is able to operate in a SOP compliant way, and to track all parameters that enable compliance to be verified.

We can Generalise to:

An automated food-fryer system configured to automatically record how it performs multiple different types of actions for which standard operating procedure (SOP) rules apply, to enable automated verification of compliance and automated tracking of non-compliance.

Optional Features
The system is configured to track SOP parameters that enable SOP compliance to be verified:
The standard operating procedure parameters include any of the following:
   Correctly load frying baskets with the correct amount of uncooked food.
   Remove food from the hot oil wells at the correct time
   Drain the food for the correct amount of time
   Minimise the delay between removing food from the fryer and moving to the holding environment or dump
   Season with the correct amount (customised to the quantity of food cooked)
   Ensure that seasoning is distributed over the entire batch of food
   Agitate foods constantly or regularly to prevent pockets of moist air forming
   Guarantee that food is wasted or binned after their quality lifetime is exceeded
The system includes any feature defined in any preceding Feature or any preceding optional feature.

Feature W: Automated Food Fryer System with ‘Buffer Quantity’ Cooking Mode

Setting the production rate of an automated food fryer system can be done in various ways; in the Fryr system, there are multiple different cooking modes, including: Cook on demand; cook to order; cook to learned schedule; and cook to product availability quantity (or buffer quantity). In this feature, we will focus on the final mode; it allows the kitchen staff or a remote manager to set the target ‘buffer’ quantity of food held in the food dump at any time. For example, for fries, the buffer quantity could be set at 10 portions of fries—i.e. the Fryr system will automatically alter the production rate to maintain approximately 10 portions of fries in the food dump at that time. The actual quantity can be less or more: it is set to be sufficiently high that customers can be quickly served—i.e. the food dump keeps enough fresh (i.e. not time expired) fries so that customers can be served from the dump and do not have to wait for fresh fries to be cooked. But the quantity is not so high that too many fries in the dump time expire and have to be discarded. The quantity can be derived automatically from the restaurant management system that tracks food orders.

It is also possible to rely on kitchen staff assessing the quantity in the dump when they take food out of it: they can control a simple dial or other input signal on the food-fryer system to either increase or decrease or maintain the production rate. So if, to the kitchen staff, it looks like the number of portions of fries held in the dump as a buffer is significantly below the target, say 10 portions, then they can adjust up the production rate. Equally, if they see a large party arrive in the restaurant, then they can adjust up the production rate temporarily to maximum. Conversely, at quiet time that are likely to persist for a time, then they can adjust the production rate down to minimise wasted fries. This gives a simple, robust and easy to understand approach to adjusting the production rate: the kitchen staff simply have to monitor the quantity of fries in the dump and to adjust the settings to keep this, more or less, at a set level.

We can Generalise to:

An automated food-fryer system configured to automatically cook batches of food at a production rate calculated to be sufficient to provide a pre-set amount of cooked product available in a food dump (the ‘buffer quantity’).

Optional Features:
The production rate is closed loop controlled to maintain the amount of cooked product at the buffer quantity as the buffer is depleted by order fulfilment.
The buffer quantity is derived automatically from the restaurant management system that tracks food orders.
The optimal size of the buffer quantity is determined from the current order frequency measured over a time period similar to the cooking time.
The current order frequency is low pass filtered to provide a smoother signal.
the current order frequency is coupled with a look ahead calculation based on the rate of change of order frequency so that the buffer quantity responds quickly to a rapid increase in the order frequency.
The food-fryer system is configured with an override cooking mode that sets the production rate at the maximum possible.
The food-fryer system is configured to automatically cook batches of food at a production rate determined a-priori based on learned information about customer behaviour, such as variable environmental factors such as the weather, finish time of local football match, automatically determined measures of restaurant busyness anticipating order requests.
An input device, such as a dial or other input controlled by kitchen staff, provides a signal to the food-fryer system to either increase or decrease or maintain the production rate.
The system includes any feature defined in any preceding Feature or preceding optional feature.

1.-90. (canceled)

91. An automated food-fryer system that is configured to automatically move a food-fryer basket from a frozen food dispenser to a cooking well and then to a food dump, the automated food-fryer system comprising:
the cooking well including one or more cooking wells; and
a basket transport system,
wherein the basket transport system includes a plurality of separate transport modules that are configured to automatically move the basket, the basket transport system comprising:
a dispenser transport module configured to move the basket to and away from the frozen food dispenser; and
a well transport module configured to lower the basket into the cooking well and lift it up from the cooking well,
wherein the well transport module includes one or more well transport modules for each of the one or more cooking wells, and
wherein the dispenser transport module is configured to move the basket independently of the one or more well transport modules moving another basket.

92. The automated food-fryer system of claim 91, in which an overall production rate of the automated food-fryer system is optimized by a computer-implemented scheduling of basket movement, enabling one or more of the transport modules to automatically queue or buffer baskets with uncooked food until they can be transferred to another transport module.

93. The automated food-fryer system of claim 91, in which a computer-implemented software system controls the basket transport system, the frozen food dispenser, and the cooking well.

94. The automated food-fryer system of claim 91, in which the dispenser transport module is configured to move at least one basket at the same time that the well transport module is moving another basket.

95. The automated food-fryer system of claim 91, in which the dispenser transport module is configured to move one or more baskets at the same time as one or more well transport modules are each moving the basket in or out of a well or maintaining the basket in a well.

96. The automated food-fryer system of claim 91 in which the basket transport system further includes a main transport module that extends over the one or more cooking wells and the food dump.

97. The automated food-fryer system of claim 96, in which the well transport module is to transfer a filled basket to the main transport module.

98. The automated food-fryer system of claim 91, in which the one or more well transport modules are linear transport modules that enable the basket to be moved solely in a vertical direction, down into the cooking well and up from the cooking well.

99. The automated food-fryer system of claim 91, in which the well transport module includes a mechanism configured to grip the basket.

100. The automated food-fryer system of claim 91, in which the one or more well transport modules include a shaker mechanism configured to shake or agitate the basket, whilst the basket is in the cooking well to minimize food sticking together, and/or after the basket has been lifted up from the cooking well to shake excess oil off the food.

101. The automated food-fryer system of claim 91, in which each transport module is configured to move at least one basket at the same time as another transport module is moving another basket.

102. The automated food-fryer system of claim 91, in which each transport module is configured to move at least one basket independently of another transport module moving another basket.

103. The automated food-fryer system of claim 91, in which each transport module is configured to move at least one basket asynchronously with respect to another transport module's movement of another basket.

104. The automated food-fryer system of claim 91, in which at least one transport module serves as a buffer or queue for baskets that are waiting collection by or transfer to a different transport module.

105. The automated food-fryer system of claim 91, in which the food-fryer system is configured to enable a human operator to manually move a basket into and out of any unused wells and to transfer food into the food dump.

106. The automated food-fryer system of claim 91, in which the food-fryer system is configured so that the wells and the dump can be manually accessed by a human operator in the event of a failure in an automated operation of the automated food-fryer system.

107. An automated food-fryer system that is configured to automatically move a food-fryer basket from a frozen food dispenser to a cooking well and then to a food dump, the automated food-fryer system comprising:
the cooking well including one or more cooking wells; and
a basket transport system,
wherein the basket transport system includes a plurality of separate transport modules that are configured to automatically move the basket, and
wherein the movements (i) between the food dispenser to the cooking well, and (ii) down into and up from the cooking well, are independent of, or asynchronous from, each other, and
wherein the food-fryer system includes a packaging system that automatically packages cooked food into individual portions in individual containers or papers.

108. The automated food-fryer system of claim 107, in which the packaging system is heated.

109. The automated food-fryer system of claim 107, in which the packaging system includes a salting and/or seasoning system configured to salt and/or season individual portions depending on specific requirements sent from consumers.

110. The automated food-fryer system of claim 107, in which the food-fryer system is configured to track a weight of food dispensed by the food dispenser and an amount of food, including the number of portions packaged, to determine food wastage.
